(19) United States
(12) Patent Application Publication
(10) Pub. No.: US 2026/0309210 A1
(43) Pub. Date: Oct. 8, 2026

(54) INFINITE TRANSMISSION RATIO RANGE EXTENDER FOR CVT'S

(71) Applicant: Armin Sebastian Tay, Waco, TX (US)

(72) Inventor: Armin Sebastian Tay, Waco, TX (US)

(21) Appl. No.: 19/479,282

(22) PCT Filed: Dec. 27, 2023
(86) PCT No.: PCT/US2023/086070

§ 371 Date: Oct. 27, 2025

(51) Int. Cl. F16H 9/12; F16D 11/14; F16D 23/02

(52) U.S. Cl. CPC F16H 9/12; F16D 11/14; F16D 23/02

(57) ABSTRACT

A transmission ratio Extender (37) for CVT's that extends the Transmission Ratio Range of the Extender (1) of the prior art by allowing the entire Transmission Ratio Shifting Range of the Extender (1) of the prior art to be repeated at a higher transmission ratio indefinitely. The Transmission Ratio Range of the Extender (1) of the prior is extended in a cost and performance effective manner by methodically using a Gearbox (38), a Load Isolating Clutch (39), and Overlap Providing Clutches (56). Being able to extend the Transmission Ratio Range of a CVT indefinitely effectively is significant; since the Transmission Ratio Range of a CVT has always been a problem for CVT's, even with the extension provided by the Extender (1) of the prior art.

### CROSS-REFERENCE TO RELATED APPLICATIONS

This invention is entitled to the benefits of:
Provisional Patent Application (PPA) Ser. No. 63/469,449 filed on 29 May 2023
Provisional Patent Application (PPA) Ser. No. 63/469,451 filed on 29 May 2023
Provisional Patent Application (PPA) Ser. No. 63/469,787 filed on 30 May 2023
Provisional Patent Application (PPA) Ser. No. 63/470,398 filed on 1 Jun. 2023
Provisional Patent Application (PPA) Ser. No. 63/470,986 filed on 5 Jun. 2023
Provisional Patent Application (PPA) Ser. No. 63/471,236 filed on 5 Jun. 2023
Provisional Patent Application (PPA) Ser. No. 63/521,200 filed on 15 Jun. 2023
Provisional Patent Application (PPA) Ser. No. 63/521,908 filed on 20 Jun. 2023
Provisional Patent Application (PPA) Ser. No. 63/522,273 filed on 21 Jun. 2023
Provisional Patent Application (PPA) Ser. No. 63/523,135 filed on 26 Jun. 2023
Provisional Patent Application (PPA) Ser. No. 63/524,903 filed on 4 Jul. 2023
Provisional Patent Application (PPA) Ser. No. 63/537,175 filed on 7 Sep. 2023
Provisional Patent Application (PPA) Ser. No. 63/539,352 filed on 20 Sep. 2023
Provisional Patent Application (PPA) Ser. No. 63/539,916 filed on 22 Sep. 2023
Provisional Patent Application (PPA) Ser. No. 63/540,028 filed on 22 Sep. 2023
Provisional Patent Application (PPA) Ser. No. 63/540,634 filed on 26 Sep. 2023
Provisional Patent Application (PPA) Ser. No. 63/540,890 filed on 27 Sep. 2023
Provisional Patent Application (PPA) Ser. No. 63/542,129 filed on 3 Oct. 2023
Provisional Patent Application (PPA) Ser. No. 63/543,300 filed on 10 Oct. 2023
Provisional Patent Application (PPA) Ser. No. 63/602,403 filed on 23 Nov. 2023

### BACKGROUNG-FIELD OF INVENTION

This invention relates to torque/speed transmissions, specifically to mechanism that can be used to extend the transmission ratio range of Continuously Variable Transmissions (CVT's).

### BACKGROUNG-DESCRIPTION OF PRIOR ART

A Transmission Ratio Extender, which is a mechanism that can be used to extend the transmission ratio range of CVT's was disclosed in the prior art U.S. Pat. No. 8,540,596 by Naude. The portion of the Transmission Ratio Extender of the prior art that are used in this disclosure, is shown FIGS. 1 to 6; where this mechanism is labeled as Extender 1.

Extender 1 is used to extend the transmission ratio range of a CVT, which comprises of an Input Cone 9 that is coupled by a CVT Transmission Belt 10 to an Output Cone 11, see FIGS. 1 to 4.

Extender 1 has an Input Shaft/Spline 2 to which an Input Shaft/Spline 1st Path Input Pulley 3 and an Input Shaft/Spline 2nd Path Input Pulley 4 are mounted; in a manner such that they can be alternately rotationally fixed relative to Input Shaft/Spline 2 through the use of an Input Shaft/Spline Clutch 5.

Input Shaft/Spline Clutch 5 is shown in details in FIG. 6. Input Shaft/Spline Clutch 5 comprises of a Clutch Gear 5-S1 that is fixed to Input Shaft/Spline 2nd Path Input Pulley 4, Synchronizer Hub 5-S2 that is fixed to Input Shaft/Spline 2, a Clutch Gear 5-S3 that is fixed to Input Shaft/Spline 1st Path Input Pulley 3, and a Shift Sleeve 5-S4. Input Shaft/Spline 2nd Path Input Pulley 4 and its Clutch Gear 5-S1 can freely rotate relative to Input Shaft/Spline 2. And likewise, Input Shaft/Spline 1st Path Input Pulley 3 and its Clutch Gear 5-S3 can freely rotate relative to Input Shaft/Spline 2.

Input Shaft/Spline Clutch 5 is used to either rotatably fix Input Shaft/Spline 2nd Path Input Pulley 4 (through Clutch Gear 5-S1) or Input Shaft/Spline 1st Path Input Pulley 3 (through Clutch Gear 5-S3) to Input Shaft/Spline 2, by shifting/sliding Shift Sleeve 5-S4. Shift Sleeve 5-S4 has internal teeth that can engage with the teeth of Clutch Gear 5-S1, the teeth of Synchronizer Hub 5-S2, and the teeth of Clutch Gear 5-S3. Synchronizer Hub 5-S2 is fixed for rotation relative to Input Shaft/Spline 2; as such when Shift Sleeve 5-S4 couples Clutch Gear 5-S1 with Synchronizer Hub 5-S2, Clutch Gear 5-S1 is fixed for rotation relative to Input Shaft/Spline 2, and when Shift Sleeve 5-S4 couples Clutch Gear 5-S2 with Synchronizer Hub 5-S2, Clutch Gear 5-S3 is fixed for rotation relative to Input Shaft/Spline 2.

For the 1st Path of Extender 1, Input Shaft/Spline 1st Path Input Pulley 3 is coupled by an Input Shaft/Spline 1st Path Transmission Belt 6 to an Input Shaft/Spline 1st Path Output Pulley 7, which is rotationally fixed relative to an Input Intermediate Shaft/Spline 8. Also rotationally fixed on Input Intermediate Shaft/Spline 8 is Input Cone 9. Input Cone 9 is coupled by a CVT Transmission Belt 10 to Output Cone 11. Output Cone 11 is rotationally fixed to an Output Intermediate Shaft/Spline 12.

An Output Shaft/Spline 13 is slid onto Output Intermediate Shaft/Spline 12 so that it can rotate relative to Output Intermediate Shaft/Spline 12. And mounted on Output Shaft/Spline 13 is an Output Shaft/Spline 2nd Path Output Pulley 14. Output Shaft/Spline 2nd Path Output Pulley 14 is mounted so that it is axially fixed, but can freely rotate relative to relative to Output Shaft/Spline 13.

Output Cone 11 and Output Shaft/Spline 2nd Path Output Pulley 14 can be alternately rotationally fixed relative to Output Shaft/Spline 13 through the use of an Output Shaft/Spline Clutch 15.

Output Shaft/Spline Clutch 15 is shown in details in FIG. 5. Output Shaft/Spline Clutch 15 comprises of a Clutch Gear 15-S1 that is fixed to Output Shaft/Spline 2nd Path Output Pulley 14, Synchronizer Hub 15-S2 that is fixed to Output Shaft/Spline 13, a Clutch Gear 15-S3 that is fixed to Output Cone 11, and a Shift Sleeve 15-S4. Output Shaft/Spline 2nd Path Output Pulley 14 and its Clutch Gear 15-S1 can freely rotate relative to Output Shaft/Spline 13. And likewise, Output Cone 11 and its Clutch Gear 15-S3 can freely rotate relative to Output Shaft/Spline 13.

Output Shaft/Spline Clutch 15 is used to either rotatably fix Output Shaft/Spline 2nd Path Output Pulley 14 (through Clutch Gear 15-S1) or Output Cone 11 (through Clutch Gear 15-S3) to Output Shaft/Spline 13, by shifting/sliding Shift Sleeve 15-S4. Shift Sleeve 15-S4 has internal teeth that can engage with the teeth of Clutch Gear 15-S1, the teeth of Synchronizer Hub 15-S2, and the teeth of Clutch Gear 15-S3. Synchronizer Hub 15-S2 is fixed for rotation relative to Output Shaft/Spline 13; as such when Shift Sleeve 15-S4 couples Clutch Gear 15-S1 with Synchronizer Hub 15-S2, Clutch Gear 15-S1 is fixed for rotation relative to Output Shaft/Spline 13, and when Shift Sleeve 15-S4 couples Clutch Gear 15-S2 with Synchronizer Hub 15-S2, Clutch Gear 15-S3 is fixed for rotation relative to Output Shaft/Spline 13.

For the 2nd Path of Extender 1, Input Shaft/Spline 2nd Path Input Pulley 4 is coupled by an Input Shaft/Spline 2nd Path Transmission Belt 16 to an Input Shaft/Spline 2nd Path Output Pulley 17, which like Output Cone 11, is also rotationally fixed relative to Output Intermediate Shaft/Spline 12.

And as described earlier Output Cone 11 is coupled by a CVT Transmission Belt 10 to an Input Cone 9. Input Cone 9 is rotationally fixed to Input Intermediate Shaft/Spline 8. Also fixed to Input Intermediate Shaft/Spline 8 is an Output Shaft/Spline 2nd Path Input Pulley 18. Output Shaft/Spline 2nd Path Input Pulley 18 is coupled by an Output Shaft/Spline 2nd Path Transmission Belt 19 to Output Shaft/Spline 2nd Path Output Pulley 14.

Extender 1 has to two paths, Path 1 and Path 2. For Path 1, Input Shaft/Spline 1st Path Input Pulley 3 is fixed for rotation relative to Input Shaft/Spline 2 through the use of Input Shaft/Spline Clutch 5, and Output Cone 11 is fixed for rotation relative to Output Shaft/Spline 13 through the use of Output Shaft/Spline Clutch 15; so that power flows as follows: Input Shaft/Spline 2 to Input Shaft/Spline 1st Path Input Pulley 3 to Input Shaft/Spline 1st Path Transmission Belt 6 to Input Shaft/Spline 1st Path Output Pulley 7 to Input Intermediate Shaft/Spline 8 to Input Cone 9 to CVT Transmission Belt 10 to Output Cone 11 to Output Shaft/Spline 13. Path 1 is shown in FIGS. 1 and 2.

For Path 2, Input Shaft/Spline 2nd Path Input Pulley 4 is fixed for rotation relative to Input Shaft/Spline 2 through the use of Input Shaft/Spline Clutch 5, and Output Shaft/Spline 2nd Path Output Pulley 14 is fixed for rotation relative to Output Shaft/Spline 13 through the use of Output Shaft/Spline Clutch 15; so that power flows as follows: Input Shaft/Spline 2 to Input Shaft/Spline 2nd Path Input Pulley 4 to Input Shaft/Spline 2nd Path Transmission Belt 16 to Input Shaft/Spline 2nd Path Output Pulley 17 to Output Intermediate Shaft/Spline 12 to Output Cone 11 to CVT Transmission Belt 10 to Input Cone 9 to Input Intermediate Shaft/Spline 8 to Output Shaft/Spline 2nd Path Input Pulley 18 to Output Shaft/Spline 2nd Path Transmission Belt 19 to Output Shaft/Spline 2nd Path Output Pulley 14 to Output Shaft/Spline 13. Path 2 is shown in FIGS. 3 and 4.

And for Path 1, CVT Transmission Belt 10 is positioned at the left-ends of Input Cone 9 and Output Cone 11 for the Initial Transmission Ratio of the CVT (see FIG. 1); and positioned at the right-ends of Input Cone 9 and Output Cone 11 for the Final Transmission Ratio of the CVT (see FIG. 2).

And for Path 2, CVT Transmission Belt 10 is positioned at the right-ends of Input Cone 9 and Output Cone 11 for the Initial Transmission Ratio of the CVT (see FIG. 3); and positioned at the left-ends of Input Cone 9 and Output Cone 11 for the Final Transmission Ratio of the CVT (see FIG. 4).

The speed change ratios of Extender 1, which are: a) the speed change ratio of Input Shaft/Spline 1st Path Output Pulley 7 compared to Input Shaft/Spline 1st Path Input Pulley 3; b) the speed change ratio of Input Shaft/Spline 2nd Path Output Pulley 17 compared to Input Shaft/Spline 2nd Path Input Pulley 4; c) the speed change ratio of Output Shaft/Spline 2nd Path Output Pulley 14 compared to Output Shaft/Spline 2nd Path Input Pulley 18; and d) the speed change ratio of the CVT (which depends on the pitch diameter of Input Cone 9, and on the pitch diameter of Output Cone 11) should be selected so that at the Final Transmission Ratio of Path 1 (see FIG. 2) and the Initial Transmission Ratio of Path 2 (see FIG. 3), the rotational speed of Input Shaft/Spline 1st Path Input Pulley 3 is identical to the rotational speed of Input Shaft/Spline 2nd Path Input Pulley 4, and the rotational speed of Output Cone 11 is identical to the rotational speed of Output Shaft/Spline 2nd Path Output Pulley 14.

The configuration above, is the configuration of the extender of the prior art that was disclosed in U.S. Pat. No. 8,540,596. The extender of the prior art extends the transmission ratio range of a CVT as follows: like a regular CVT, the transmission ratio of Path 1 can be changed from its Initial Transmission Ratio to its Final Transmission Ratio (see FIGS. 1 and 2). Then the transmission ratio range can be extended by changing Path 1, which is at its Final Transmission Ratio (see FIG. 2), to Path 2, which is at its Initial Transmission Ratio (see FIG. 3). The speed change ratios of Extender 1 are selected so that the transmission ratio of Extender 1 at the Initial Transmission Ratio of Path 2 (see FIG. 3) matches the transmission ratio of Extender 1 at Final Transmission Ratio of Path 1 (see FIG. 2); and the transmission ratios from above the Initial Transmission Ratio of Path 2 (see FIG. 3) to the Final Transmission Ratio of Path 2 (see FIG. 4) is the transmission ratio range extension over a regular CVT.

### BRIEF SUMMARY OF THE INVENTION

A transmission ratio Extender (37) for CVT's that extends the Transmission Ratio Range of the Extender (1) of the prior art by allowing the entire Transmission Ratio Shifting Range of the Extender (1) of the prior art to be repeated at a higher transmission ratio indefinitely.

There are many ways that the Transmission Ratio Range of the Extender (1) of the prior art can be extended, such as by using two Planetary Gearbox Assemblies (36) as described in the First Embodiment of this disclosure. This solution was once deemed as the only solution; but it would have been cost prohibitive, since this mechanism alone can cost as much an automatic transmission. Additionally, this mechanism provides a much smaller Transmission Ratio Range Extension than the preferred Second Embodiment of this disclosure.

For the preferred Second Embodiment, which is said Extender (37), the Transmission Ratio Range of the Extender (1) of the prior is extended in a cost and performance effective manner by methodically using a Gearbox (38), a Load Isolating Clutch (39), and Overlap Providing Clutches (56). By adding gear ratios to said Gearbox (38), the Transmission Ratio Range of said Extender (37) can be increased indefinitely.

Being able to extend the Transmission Ratio Range of a CVT indefinitely effectively is significant; since the Transmission Ratio Range of a CVT was always a problem for CVT's, even with the extension provided by the Extender (1) of the prior art.

### BRIEF DESCRIPTION OF THE SEVERAL VIEWS OF THE DRAWING

FIG. 1 shows the Configuration of Extender 1 for “Path 1—Initial Transmission Ratio”.

FIG. 2 shows the Configuration of Extender 1 for “Path 1—Final Transmission Ratio”.

FIG. 3 shows the Configuration of Extender 1 for “Path 2—Initial Transmission Ratio”.

FIG. 4 shows the Configuration of Extender 1 for “Path 2—Final Transmission Ratio”.

FIG. 5 shows the details for Output Shaft/Spline Clutch 15.

FIG. 6 shows the details for Input Shaft/Spline Clutch 5.

FIG. 7 shows the Configuration of Extender 21 for Path 2—Final Transmission Ratio.

FIG. 8 shows the Configuration of Extender 21 for Path 1—Initial Transmission Ratio—2nd Run.

FIG. 9 shows the Configuration of Extender 21 for Path 2—Final Transmission Ratio—1st Run, with exemplary speed ratios.

FIG. 10 shows the Configuration of Extender 21 for Path 1—Initial Transmission Ratio—2nd Run, with exemplary speed ratios.

FIG. 11 shows front-view of Ring Gear 25, Input Shaft/Spline 24, and Output Shaft/Spline 26 of a Planetary Gearbox Sub-Assembly 27.

FIG. 12 shows front-view of Planetary Gearbox Sub-Assembly 27.

FIG. 13 shows front-view of Ring Gear Frame Locking Front Cover 28.

FIG. 14 shows right-side-view of Ring Gear Frame Locking Front Cover 28.

FIG. 15 shows front-view of Ring Gear Input Shaft/Spline Locking Disk 29.

FIG. 16 shows right-side-view of Ring Gear Input Shaft/Spline Locking Disk 29.

FIG. 17 shows front-view of Ring Gear Frame Locking Rear Cover 30.

FIG. 18 shows right-side-view of Ring Gear Frame Locking Rear Cover 30.

FIG. 19 shows front-view of Ring Gear Output Shaft/Spline Locking Sleeve 31.

FIG. 20 shows right-side-view of Ring Gear Output Shaft/Spline Locking Sleeve 31.

FIG. 21 shows the configuration of Planetary Gearbox Assembly 36 for which the adjusted ratio is obtained.

FIG. 22 shows the configuration of Planetary Gearbox Assembly 36 for which the 1:1 ratio is obtained.

FIG. 23 shows the configuration of Planetary Gearbox Assembly 36 for which the 1:1 ratio is obtained.

FIG. 23 shows the right-side-view of FIGS. 21 and 22.

FIG. 24 shows the Configuration of Extender 37 for “Path 1—1st Run—Initial Transmission Ratio”.

FIG. 25 shows the Configuration of Extender 37 for “Path 1—-1st Run-Final Transmission Ratio”.

FIG. 26 shows the Configuration of Extender 37 for “Path 2—1st Run—Initial Transmission Ratio”.

FIG. 27 shows the Configuration of Extender 37 for “Path 2—1st Run—Final Transmission Ratio”.

FIG. 28 shows the Configuration of Extender 37 for “Path 1—2nd Run—Initial Transmission Ratio”.

FIG. 29 shows the Configuration of Extender 37 for “Path 1—2nd Run—Final Transmission Ratio”.

FIG. 30 shows the Configuration of Extender 37 for “Path 2—2nd Run—Initial Transmission Ratio”.

FIG. 31 shows the Configuration of Extender 37 for “Path 1—2nd Run—Final Transmission Ratio”.

FIG. 32 show the configuration for Extender 37 for which the positions of Gearbox 38 and Load Isolating Clutch 39 are switched compared to their positions shown in FIG. 24.

FIG. 33 shows a Sliding Sleeve 40 for an Overlap Providing Clutch 56.

FIG. 34 shows a Transmission Member 41.

FIG. 35 shows a Clutch Gear 42.

FIG. 36 shows an assembled Sliding Sleeve 40, which include Clutch Gear 42, Transmission Member 41, and Locking Ring 43.

FIG. 37 shows how assembled Sliding Sleeve 40 and some other parts of Overlap Providing Clutch 56 are assembled on a Transmission Shaft/Spline 44. In this figure, Clutch Gear 42 is retracted.

FIG. 38 shows how assembled Sliding Sleeve 40 and some other parts of Overlap Providing Clutch 56 are assembled on a Transmission Shaft/Spline 44. In this figure, Clutch Gear 42 is extended.

FIG. 39 shows a front-view of a Blocker Ring 50.

FIG. 40 shows a right-side-view of a Blocker Ring 50.

FIG. 41 shows a front-view of a Pusher Plate 51.

FIG. 42 shows a right-side-view of a Pusher Plate 51.

FIG. 43 shows a front-view of Blocker Ring 50 to which Pusher Plate 51 is fixed.

FIG. 44 shows a right-side-view of Blocker Ring 50 to which Pusher Plate 51 is fixed.

FIG. 45 shows a front-view of a Blocker Ring 52.

FIG. 46 shows a right-side-view of a Blocker Ring 52.

FIG. 47 shows a front-view of a Pusher Plate 53.

FIG. 48 shows a right-side-view of a Pusher Plate 53.

FIG. 49 shows a front-view of Blocker Ring 52 to which Pusher Plate 53 is fixed.

FIG. 50 shows a right-side-view of Blocker Ring 52 to which Pusher Plate 53 is fixed.

FIG. 51 shows a front-view of a Shift Sleeve 54.

FIG. 52 shows a right-side-view of Shift Sleeve 54.

FIG. 53 shows a top-view of Shift Sleeve 54.

FIG. 54 shows an Overlap Providing Clutch 56. In this figure, Clutch Gear 42 is retracted, and Shift Sleeve 54 is engaged with Clutch Gear 42.

FIG. 55 shows Overlap Providing Clutch 56. In this figure, Clutch Gear 42 is extended, and Shift Sleeve 54 is engaged with Clutch Gear 42.

FIG. 56 shows Overlap Providing Clutch 56. In this figure, Clutch Gear 42 is extended, and Shift Sleeve 54 is engaged with Clutch Gear 46.

FIG. 57 shows Overlap Providing Clutch 56. In this figure, Clutch Gear 42 is retracted, and Shift Sleeve 54 is engaged with Clutch Gear 46.

FIG. 58 shows an Overlap Providing Clutch 56A. In this figure, Clutch Gear 42 and Clutch Gear 46A are both retracted.

FIG. 59 shows Overlap Providing Clutch 56A. In this figure, Clutch Gear 42 and Clutch Gear 46A are both extended.

FIG. 60 shows Overlap Providing Clutch 56A. In this figure, Clutch Gear 42 is retracted while Clutch Gear 46A is extended.

FIG. 61 shows the Configuration of Extender 37A.

### Reference Numerals in Drawings

For the reference numerals in this specification, if used, the label M(number) after a labeling, where (number) is a number, such as M2 for example, is used to label different members of a part that is grouped under one label. And if used, the label S(number) after a labeling, where (number) is a number, such as S2 for example, is used to label the different shapes of a part that is grouped under one label.

Furthermore, the same parts that are used in different location might have a different labeling letter after their reference numeral, or a different reference numeral altogether if this is helpful in describing the invention. If two parts have the same reference numeral then they are identical unless otherwise described.

### DETAILED DESCRIPTION OF THE INVENTION

### First Embodiment—Extender with Two Planetary Gearboxes

All embodiments of this section are not encompassed by the wording of the claims but are considered as useful for understanding the invention.

Described in this section is an Extender 21. Extender 21 extends the transmission ratio range of Extender 1 as follows: once Path 2 has reached its Final Transmission Ratio; Path 2 (which is at its Final Transmission Ratio) is changed to Path 1 (which is at its Initial Transmission Ratio). So that additional transmission ratios are obtained by changing the Transmission Ratio of Path 2 from its Initial Transmission Ratio to its Final Transmission Ratio.

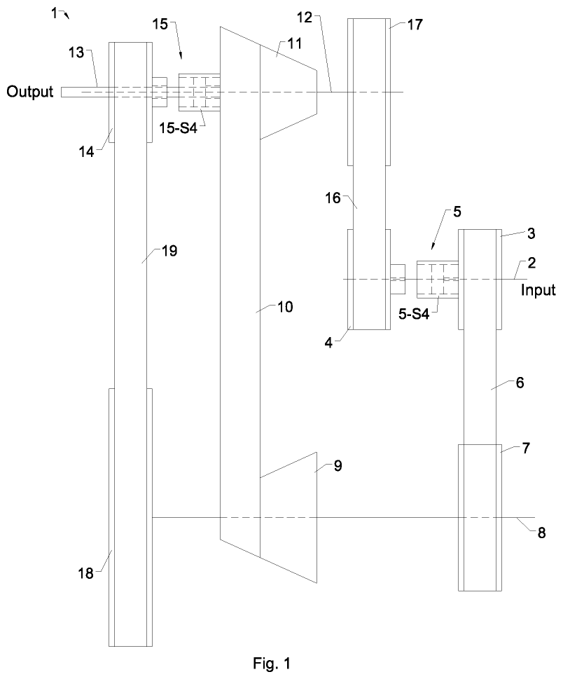

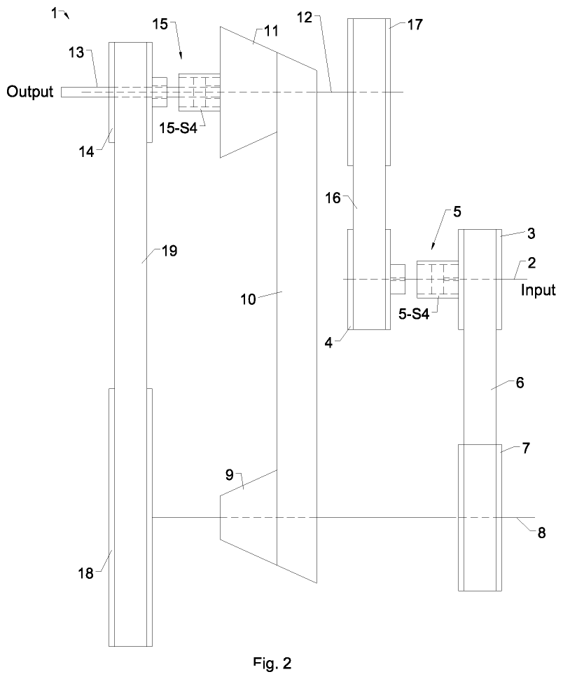

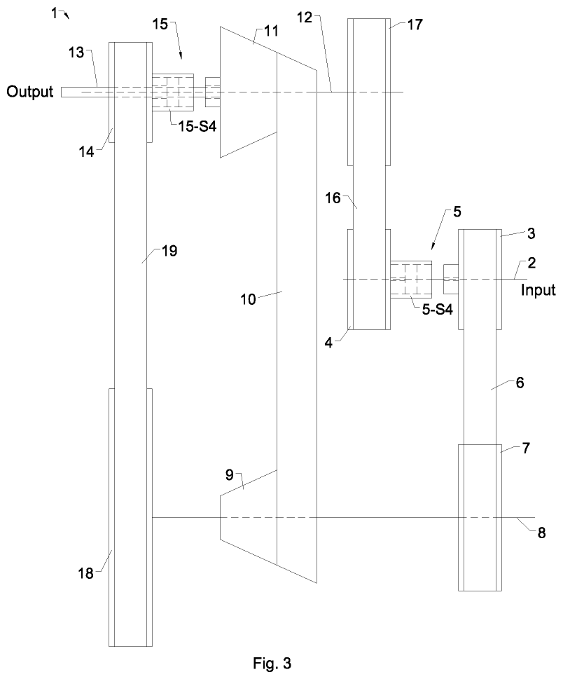

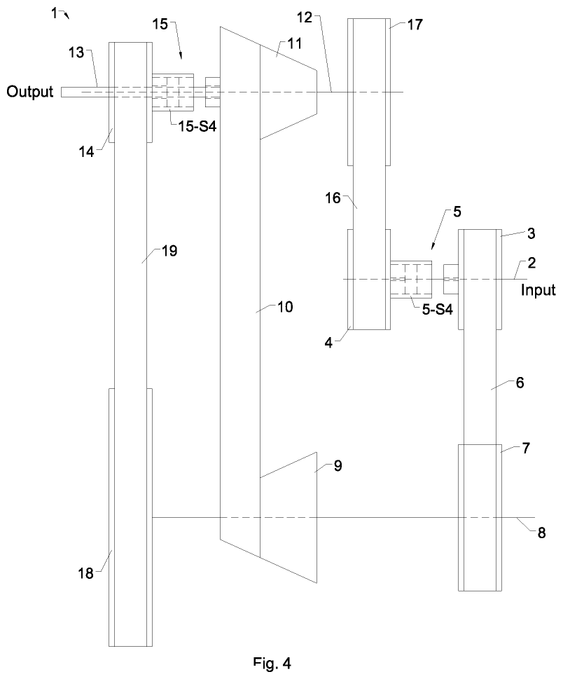

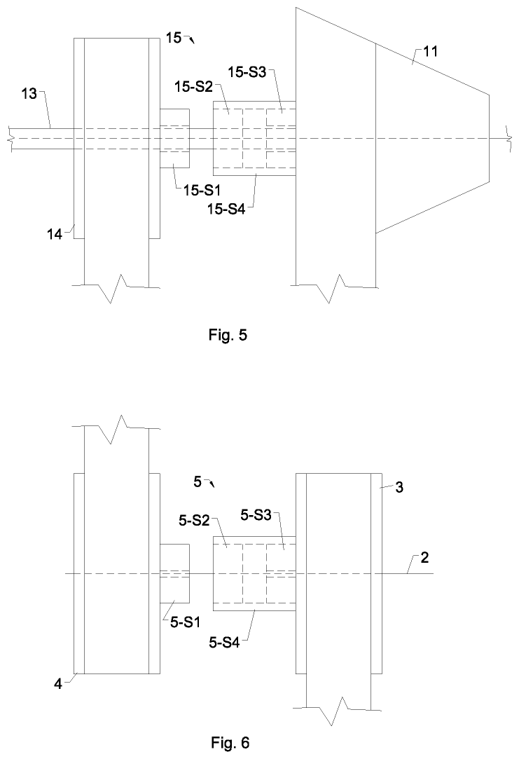

The prior art does not allow Path 2 to be changed to Path 1 at the Final Transmission Ratio of Path 2 (which is also the Initial Transmission Ratio of Path 1). It only allows Path 2 to be changed to Path 1 at the Initial Transmission Ratio of Path 2 (which is also the Final Transmission Ratio of Path 1). This is because: a) the total speed change ratio of Extender 1 is selected so that only at the Final Transmission Ratio of Path 1 (see FIG. 2) and the Initial Transmission Ratio of Path 2 (see FIG. 3), the rotational speed of Input Shaft/Spline 1st Path Input Pulley 3 is identical to the rotational speed of Input Shaft/Spline 2nd Path Input Pulley 4, and the rotational speed of Output Cone 11 is identical to the rotational speed of Output Shaft/Spline 2nd Path Output Pulley 14. And because of: b) the total speed change ratio of Extender 1 is selected so that the transmission ratio of Extender 1 at the Initial Transmission Ratio of Path 2 (see FIG. 3) matches the transmission ratio of Extender 1 at Final Transmission Ratio of Path 1 (see FIG. 2); but the transmission ratio of Extender 1 at the Initial Transmission Ratio of Path 1 (see FIG. 1) does not match the transmission ratio of Extender 1 at Final Transmission Ratio of Path 2 (see FIG. 4).

In order to allow Path 2 to be changed to Path 1 when Path 2 is at its Final Transmission Ratio, so that additional transmission ratios are obtained by changing the Transmission Ratio of Path 2 from its Initial Transmission Ratio to its Final Transmission Ratio; Planetary Gearboxes are used.

The Planetary Gearboxes are used to alter the total speed change ratio of Extender 21, by: a) providing a 1:1 ratio, such that the Planetary Gearboxes don't alter the total speed change ratio of Extender 21, so that the operation of Extender 21 matches that of Extender 1. Or by: b) by providing Adjusted Ratios, such that the Planetary Gearboxes alter the total speed change ratio of Extender 21.

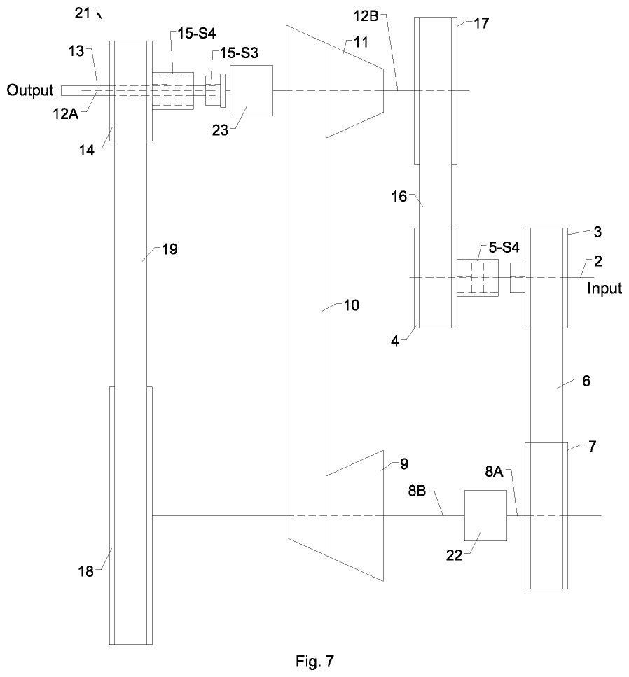

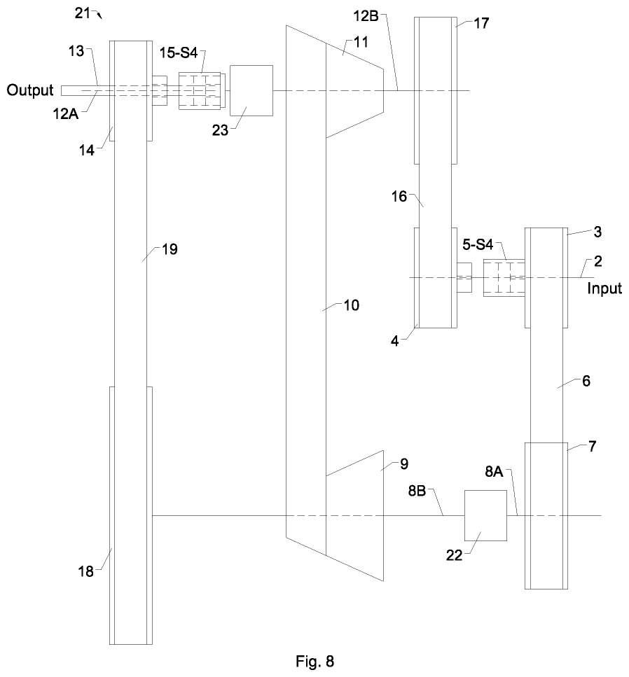

The Adjusted Ratios of the Planetary Gearboxes are selected so that: a) the total speed change ratio of Extender 21 is altered by the Adjusted Ratios of the Planetary Gearboxes so that at the Final Transmission Ratio of Path 2 (see FIG. 7) and the Initial Transmission Ratio of Path 1 (see FIG. 8), the rotational speed of Input Shaft/Spline 1st Path Input Pulley 3 is identical to the rotational speed of Input Shaft/Spline 2nd Path Input Pulley 4, and the rotational speed of Output Cone 11 is identical to the rotational speed of Output Shaft/Spline 2nd Path Output Pulley 14. And so that: b) the total speed change ratio of Extender 21 is altered by the Adjusted Ratios of the Planetary Gearboxes so that the transmission ratio of Extender 21 at the Initial Transmission Ratio of Path 1 (see FIG. 8) matches the transmission ratio of Extender 21 at Final Transmission Ratio of Path 2 (see Fig.) .

Extender 21 is shown in FIGS. 7 and 8. It is identical to Extender 1, except that it uses a Planetary Gearbox Assembly 22 and a Planetary Gearbox Assembly 23.

And since Planetary Gearbox Assembly 22 has an input shaft/spline and output shaft/spline, Input Intermediate Shaft/Spline 8 of Extender 1 is replaced with an Input Intermediate Shaft/Spline 8A and an Input Intermediate Shaft/Spline 8B for Extender 21 (see FIGS. 4 and 7). All items that are mounted on Input Intermediate Shaft/Spline 8 in Extender 1, are mounted on either Intermediate Shaft/Spline 8A or Input Intermediate Shaft/Spline 8B in Extender 21 in the same way as they are mounted Input Intermediate Shaft/Spline 8 in Extender 1.

And since Planetary Gearbox Assembly 23 has an input shaft/spline and output shaft/spline, Output Intermediate Shaft/Spline 12 of Extender 1 is replaced with an Output Intermediate Shaft/Spline 12A and an Output Intermediate Shaft/Spline 12B for Extender 21 (see FIGS. 4 and 7). All items that are mounted on Output Intermediate Shaft/Spline 12 in Extender 21, are mounted on either Output Intermediate Shaft/Spline 12A or Output Intermediate Shaft/Spline 12B in Extender 21 in the same way as they are mounted Input Intermediate Shaft/Spline 8 in Extender 1.

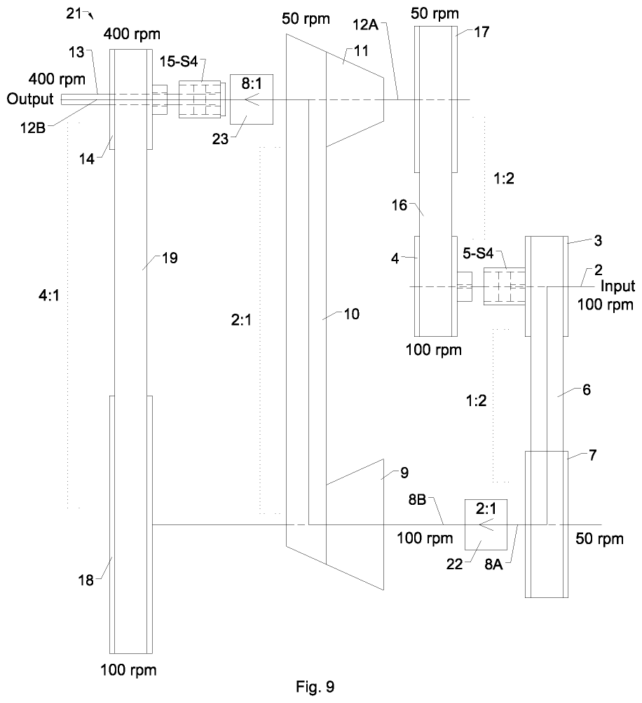

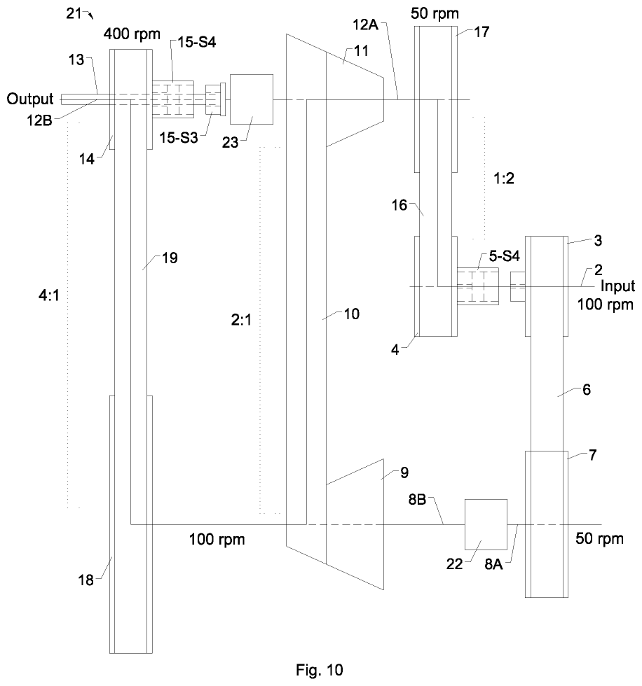

An example of an Extender 21 with its speed change ratios and its Adjusted Ratios, that allows Path 2 to be changed to Path 1 when Path 2 is at its Final Transmission Ratio, is shown in FIGS. 9 and 10. From FIG. 9 it can be observed that prior changing Path 2 to Path 1, the speed of Input Shaft/Spline 1st Path Input Pulley 3 and the speed of Input Shaft/Spline 2nd Path Input Pulley 4 are both 100 rpm; and the speed of Output Intermediate Shaft/Spline 12B and the speed of Output Shaft/Spline 2nd Path Output Pulley 14 are both 400 rpm. So that shifting can be performed without the need of speed synchronizers as in Extender 1.

For each Planetary Gearbox Assembly, the 1:1 ratio is obtained by: a) having its Ring Gear locked relative to the input shaft/spline to the Planetary Gearbox Assembly; and by: b) having the output shaft/spline of the Planetary Gearbox Assembly locked relative to the Ring Gear of the Planetary Gearbox Assembly. Note, for item a), the input shaft/spline to the Planetary Gearbox Assembly is fixed to the Sun Gear of the Planetary Gearbox Assembly; and for item b), the output shaft/spline of the Planetary Gearbox Assembly is fixed to the Planetary Carrier of the Planetary Gearbox Assembly.

And for each Planetary Gearbox Assembly, the adjusted ratio is obtained by: a) having its Ring Gear locked relative to a frame; and by: b) having the output shaft/spline of the Planetary Gearbox Assembly unlocked relative to the Ring Gear of the Planetary Gearbox Assembly.

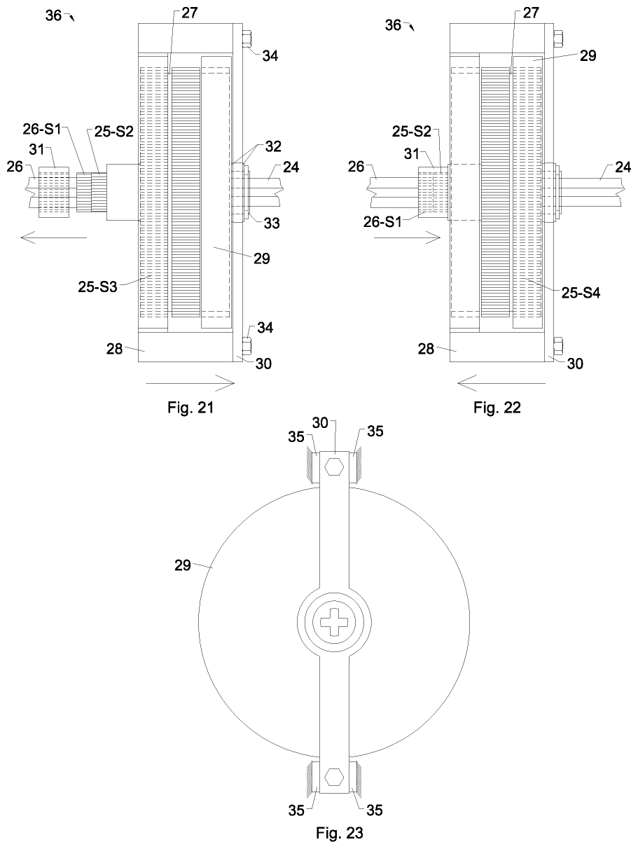

The design for Planetary Gearbox Assemblies 22 and 23 is described in the paragraphs below; where it is labeled as Planetary Gearbox Assembly 36. As can be seen in FIGS. 21 and 22, Planetary Gearbox Assembly 36 comprises of a Planetary Gearbox Sub-Assembly 27, a Ring Gear Frame Locking Front Cover 28, Ring Gear Input Shaft/Spline Locking Disk 29, a Ring Gear Frame Locking Rear Cover 30, and a Ring Gear Output Shaft/Spline Locking Sleeve 31.

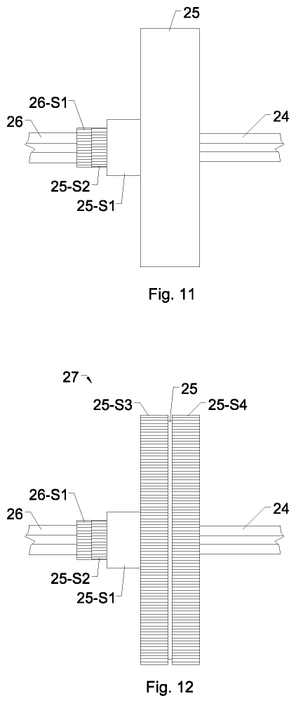

Planetary Gearbox Sub-Assembly 27 is shown in FIG. 12. It has a Ring Gear 25, Input Shaft/Spline 24, and Output Shaft/Spline 26 (see FIG. 11). Input Shaft/Spline 24 is fixed to the Sun Gear of Planetary Gearbox Assembly 27, and Output Shaft/Spline 26 is fixed to the Planet Carrier of Planetary Gearbox Assembly 27.

Ring Gear 25 has parallel side walls that enclose its Sun Gear, Planetary Gear, and Planetary Carrier shaped on its side surfaces. The side walls have holes for Input Shaft/Spline 24 and Output Shaft/Spline 26. These side walls are not shown in FIG. 11.

A centric Ring Gear Shoulder 25-S1 is shaped on the side wall of Ring Gear 25 that is located on the Output Shaft/Spline 26 side of Ring Gear 25. And at the end of Shoulder 25-S1, a Locking Gear 25-S2 is fixed. While on Output Shaft/Spline 26, a Locking Gear 26-S1 is fixed. Locking Gear 25-S2 and Locking Gear 26-S1 are used to lock Output Shaft/Spline 26 relative to Ring Gear 25 through the use of a Ring Gear Output Shaft/Spline Locking Sleeve 31 (see FIGS. 19 to 22).

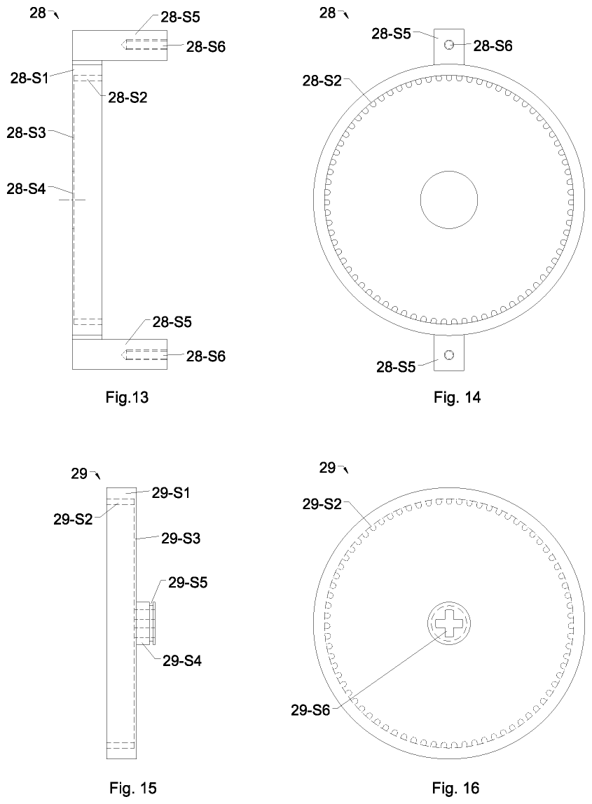

Ring Gear 25 also has a Circumferential Gear 25-S3 and a Circumferential Gear 25-S4 fixed to its circumferential outer surface, see FIG. 12. Circumferential Gear 25-S3 is used to lock Ring Gear 25 relative to a frame through the use of a Ring Gear Frame Locking Front Cover 28 (see FIGS. 13, 14, 21, and 23). And Circumferential Gear 25-S4 is used to lock Ring Gear 25 relative to Input Shaft/Spline 24 through the use of Ring Gear Input Shaft/Spline Locking Disk 29 (see FIGS. 15, 16, and 22).

Ring Gear Frame Locking Front Cover 28 is shown in FIGS. 13 and 14. The main shape of Ring Gear Frame Locking Front Cover 28 is a Cylindrical Disk 28-S1, which has a cylindrical cavity that has a Front Wall 28-S3 and Circumferential Teeth 28-S2.

Circumferential Teeth 28-S2 can engage with the teeth of Circumferential Gear 25-S3.

And Front Wall 28-S3 has a Hole 28-S4 through which Shoulder 25-S1, Output Shaft/Spline 26, and their Locking Gear 25-S2 and Locking Gear 26-S1 can be inserted.

In order to be able to secure Ring Gear Frame Locking Front Cover 28 to Ring Gear Frame Locking Rear Cover 30, Ring Gear Frame Locking Front Cover 28 has two radially oppositely positioned Attachment Arms 28-S5. Each Attachment Arm 28-S5 extends backwards from the front-end of Ring Gear Frame Locking Front Cover 28, so that it can provided a rear attachment surface on which Ring Gear Frame Locking Rear Cover 30 can be attached; for this purpose, said rear attachment surface of each Attachment Arm 28-S5 has a Threaded Hole 28-S6 (see FIGS. 13 and 14).

Ring Gear Input Shaft/Spline Locking Disk 29 is shown in FIGS. 15 and 16. The main shape of Ring Gear Input Shaft/Spline Locking Disk 29 is a Cylindrical Disk 29-S1, which has a cylindrical cavity that has a Rear Wall 29-S3 and Circumferential Teeth 29-S2.

Circumferential Teeth 29-S2 can engage with the teeth of Circumferential Gear 25-S4.

Fixed on the rear surface of Rear Wall 29-S3 is an Input Shaft/Spline Locking Sleeve 29-S4, which has Splined Hole 29-S6 through which Input Shaft/Spline 24 can be inserted so that it is rotationally fixed relative to Ring Gear Input Shaft/Spline Locking Disk 29. Input Shaft/Spline Locking Sleeve 29-S4 also has a Locking Ring Groove 29-S5; which is used to fix the axial position of Ring Gear Input Shaft/Spline Locking Disk 29 relative to Ring Gear Frame Locking Rear Cover 30 and such also Ring Gear Frame Locking Front Cover 28, through the use of a locking ring.

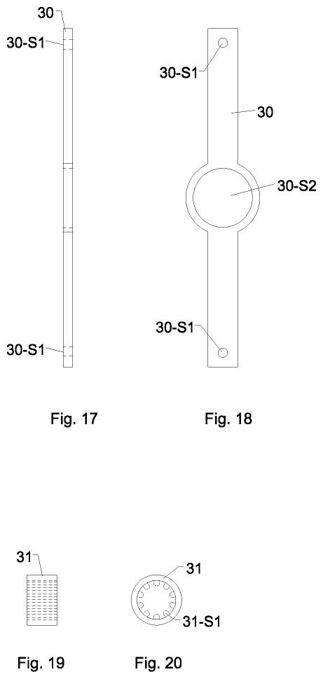

Ring Gear Frame Locking Rear Cover 30 is shown in FIGS. 17 and 18. It has the shape of an elongated plate that has two Bolt Holes 30-S1 at each end, and a Sleeve Hole 30-S2 at its center. Bolt Holes 30-S1 are located so that they can align with Threaded Holes 28-S6 of Ring Gear Frame Locking Front Cover 28; so that Ring Gear Frame Locking Rear Cover 30 can be secured to Ring Gear Frame Locking Front Cover 28 through Bolts 34 (see FIGS. 21 and 22).

And Sleeve Hole 30-S2 is dimensioned so that Input Shaft/Spline Locking Sleeve 29-S4 of Ring Gear Input Shaft/Spline Locking Disk 29 can be inserted into it. Friction between Sleeve Hole 30-S2 and Input Shaft/Spline Locking Sleeve 29-S4 should be minimized so that Ring Gear Input Shaft/Spline Locking Disk 29 can freely rotate relative to Ring Gear Frame Locking Rear Cover 30.

In order to secure Input Shaft/Spline Locking Sleeve 29-S4 to Sleeve Hole 30-S2, two Thrust Bearings 32 and a Locking Ring 33 are used. Locking Ring 33 is inserted into Locking Ring Groove 29-S5 (see FIGS. 15 and 21). And one Thrust Bearing 32 is positioned between Rear Wall 29-S3 of Ring Gear Input Shaft/Spline Locking Disk 29 and the front surface of Ring Gear Frame Locking Rear Cover 30; and the other Thrust Bearing 32 is positioned between the rear surface of Ring Gear Frame Locking Rear Cover 30 and the front surface of Locking Ring 33 (see FIGS. 15 and 21).

Ring Gear Output Shaft/Spline Locking Sleeve 31 is shown in FIGS. 19 and 20. It has the shape of a sleeve that has Internal Teeth 31-S1. Ring Gear Output Shaft/Spline Locking Sleeve 31 can be slide-ably inserted into Locking Gear 25-S2 and Locking Gear 26-S1 (see FIGS. 21 and 22). And Internal Teeth 31-S1 can engage with the teeth of Locking Gear 25-S2 and Locking Gear 26-S1 so as to lock them relative to Ring Gear Output Shaft/Spline Locking Sleeve 31, and as such also relative to each other.

FIG. 21 shows the configuration of Planetary Gearbox Assembly 36 for which the adjusted ratio is obtained. Here the “Ring Gear Frame Locking Front Cover 28 and Ring Gear Frame Locking Rear Cover 30” assembly is pushed backwards relative to Planetary Gearbox Sub-Assembly 27, so that Circumferential Gear 25-S3 is engaged with the Circumferential Teeth 28-S2 of Ring Gear Frame Locking Front Cover 28 (see also FIGS. 12, 13, and 14). Because of this Planetary Gearbox Sub-Assembly 27, and as such also Ring Gear 25, is fixed for rotation relative to Ring Gear Frame Locking Front Cover 28.

And since Ring Gear Frame Locking Front Cover 28 is fixed for rotation relative to a frame through the engagement of the surfaces of Ring Gear Frame Locking Front Cover 28 and the surfaces of Ring Gear Frame Locking Rear Cover 30 that are engaged which Constrainers 35 (see FIG. 23); Planetary Gearbox Sub-Assembly 27, and as such also Ring Gear 25, is fixed for rotation relative to a frame. Note: FIG. 23 shows the right-side-view of FIGS. 21 and 22.

Additionally, for the adjusted ratio it is not required that the output shaft/spline of the Planetary Gearbox Assembly is locked relative to the Ring Gear of the Planetary Gearbox Assembly. As such in FIG. 21, Ring Gear Output Shaft/Spline Locking Sleeve 31 is pushed away from Locking Gear 25-S2 of Ring Gear 25 and Locking Gear 26-S1 of Output Shaft/Spline 26; so that Output Shaft/Spline 26 can freely rotate relative to Ring Gear 25.

FIG. 22 shows the configuration of Planetary Gearbox Assembly 36 for which the 1:1 ratio is obtained. Here the “Ring Gear Frame Locking Front Cover 28 and Ring Gear Frame Locking Rear Cover 30” assembly is pushed forwards relative to Planetary Gearbox Sub-Assembly 27, so that Circumferential Gear 25-S4 is engaged with the Circumferential Teeth 29-S2 of Ring Gear Input Shaft/Spline Locking Disk 29 (see also FIGS. 12, 15, and 16). Because of this Planetary Gearbox Sub-Assembly 27, and as such also Ring Gear 25, is fixed for rotation relative to Ring Gear Input Shaft/Spline Locking Disk 29. And since, as described earlier, Ring Gear Input Shaft/Spline Locking Disk 29 is fixed for rotation relative to Input Shaft/Spline 24; Planetary Gearbox Sub-Assembly 27, and as such also Ring Gear 25, is also fixed for rotation relative to input Shaft/Spline 24.

Additionally, in order to obtain the 1:1 ratio, it is also required that the output shaft/spline of the Planetary Gearbox Assembly is locked relative to the Ring Gear of the Planetary Gearbox Assembly. As such in FIG. 22, Ring Gear Output Shaft/Spline Locking Sleeve 31 is pushed towards Planetary Gearbox Sub-Assembly 27 so that it engages with Locking Gear 26-S1 of Output Shaft/Spline 26 and Locking Gear 25-S2 of Ring Gear 25; so as to lock Output Shaft/Spline 26 to Ring Gear 25, as required.

### Second Embodiment—Preferred Embodiment for an Extender

### Background

The preferred embodiment of this invention is Extender 37, which is described in the paragraphs below.

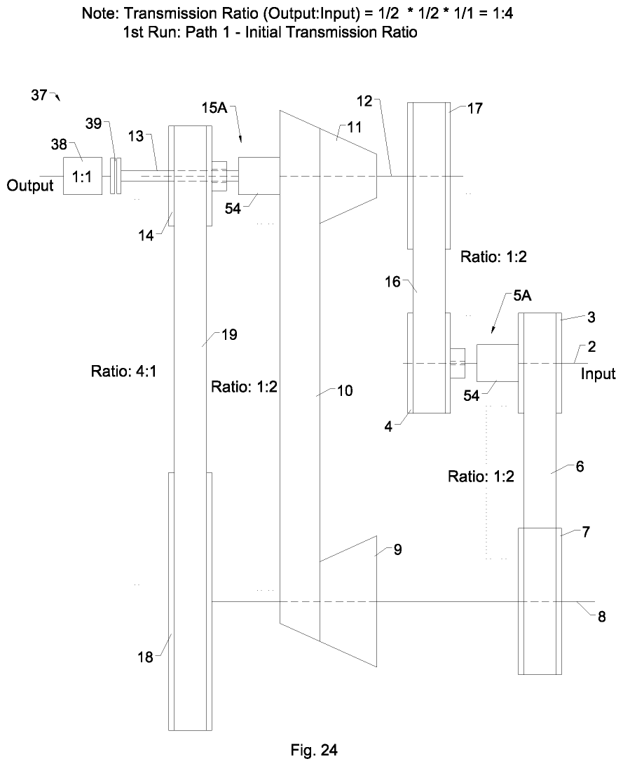

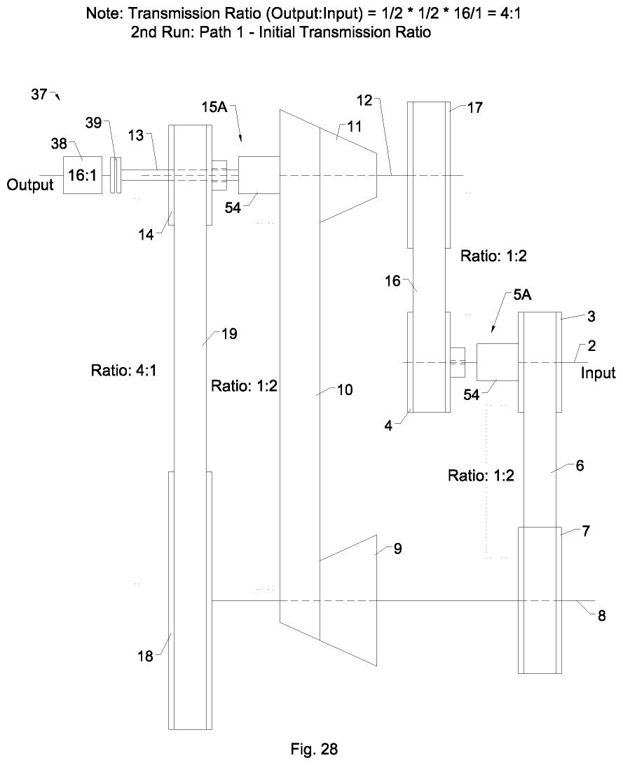

The entire Transmission Ratio Shifting Range of Extender 1, of the prior art, is shown in FIGS. 1 to 4. For Extender 37, the entire Transmission Ratio Shifting Range of Extender 1 is shown in FIGS. 24 to 27; this Transmission Ratio Shifting Range of Extender 37 is referred to as the 1st Run of Extender 37. In addition to its 1st Run, Extender 37 also has a 2nd Run, which repeats the steps of the 1st Run at a higher transmission ratio, see FIGS. 28 to 31.

In other words, the entire Transmission Ratio Shifting Range of Extender 1 is referred to as the 1st Run of Extender 37 (see FIGS. 24 to 27); and Extender 37 repeats the entire Transmission Ratio Shifting Range of its 1st Run at the higher transmission ratio, which is referred to as its 2nd Run (see FIGS. 28 to 31); so as to provide additional transmission ratios. As such, Extender 37 extends the Transmission Ratio of Range of Extender 1 (of the prior art) by allowing the entire Transmission Ratio Shifting Range of Extender 1 to be repeated at a higher transmission ratio.

The 1st Run of Extender 37 comprises of the following ranges: a) the Initial Transmission Ratio to the Final Transmission Ratio of Path 1; and b) the Initial Transmission Ratio to the Final Transmission Ratio of Path 2. In order to allow for the 2nd Run, Extender 37 allows the following over the prior art; once Path 2 has reached its Final Transmission Ratio, it can be changed back to Path 1 which is at its Initial Transmission Ratio.

### Configuration of Extender 37

Extender 37 uses the same parts as Extender 1; except in order to allow for a 2nd Run, Extender 37 also comprises of a Gearbox 38 and a Load Isolating Clutch 39; and additionally, Input Shaft/Spline Clutch 5 of Extender 1 is replaced with an Input Shaft/Spline Clutch 5A for Extender 37, and Output Shaft/Spline Clutch 15 of Extender 1 is replaced with an Output Shaft/Spline Clutch 15A for Extender 37 (see FIGS. 24 to 31).

Input Shaft/Spline Clutch 5A and an Output Shaft/Spline Clutch 15A are each an Overlap Providing Clutch 56, which will be described later.

Gearbox 38 of Extender 37 should be positioned directly or indirectly after the output of Extender 1, such as positioned directly or indirectly after Output Shaft/Spline 13. So that the ratio changes of Gearbox 38 will not affect the rotational speeds of the means for conveying rotational energy of Extender 1. Otherwise, the additional gear ratio(s) of Gearbox 38 will increase the “rotational speeds of the means for conveying rotational energy of Extender 1”; which is undesirable (more heat generated, more strain on belts due to centrifugal forces, etc.).

Load Isolating Clutch 39 is preferably positioned anywhere before the input to Extender 1 and anywhere after the output of Extender 1, such as positioned anywhere before Input Shaft/Spline 2 or anywhere after Output Shaft/Spline 13. So that no load is applied to Extender 37 once Load Isolating Clutch 39 is disengaged; since if positioned as such, Load Isolating Clutch 39 will either disengage Extender 37 with the engine/motor that drives it, or disengage Extender 37 with the load that is driven by Extender 37.

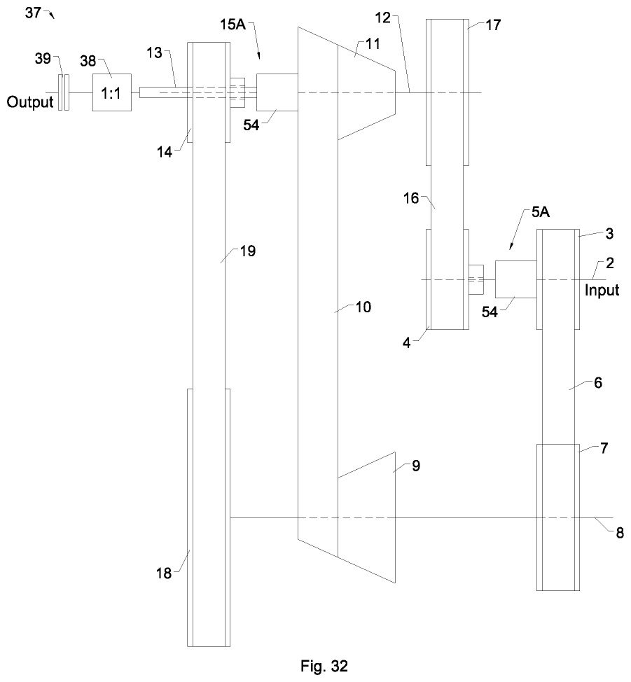

As such, Load Isolating Clutch 39 can be located before or after Gearbox 38 for example; since no load is applied to Gearbox 38 and the rest of Extender 37 once Load Isolating Clutch 39 disengaged, regardless of whether Load Isolating Clutch 39 is located before or after Gearbox 38. A configuration where Load Isolating Clutch 39 is located after Gearbox 38, is shown in FIG. 32.

Load Isolating Clutch 39 should be disengaged when Path 2 is changed to Path 1 at the Final Transmission Ratio of Path 2, and when Path 1 is changed to Path 2 at the Initial Transmission Ratio of Path 1. For all other operations of Extender 37, except when it is being used as a Neutral Transmission, Load Isolating Clutch 39 should be engaged.

Like Extender 1, Extender 37 is used to extend the transmission ratio range of a CVT, which comprises of an Input Cone 9 that is coupled by a CVT Transmission Belt 10 to an Output Cone 11, see FIGS. 24 to 32.

Extender 37 has an Input Shaft/Spline 2 to which an Input Shaft/Spline 1st Path Input Pulley 3 and an Input Shaft/Spline 2nd Path Input Pulley 4 are mounted; so that they are axially fixed relative to Input Shaft/Spline 2, but can freely rotate relative to Input Shaft/Spline 2.

An Input Shaft/Spline Clutch 5A can be used to either rotatably fix Input Shaft/Spline 2nd Path Input Pulley 4 or Input Shaft/Spline 1st Path Input Pulley 3 to Input Shaft/Spline 2, by shifting/sliding a Shift Sleeve 54.

For the 1st Path of Extender 37, Input Shaft/Spline 1st Path Input Pulley 3 is coupled by an Input Shaft/Spline 1st Path Transmission Belt 6 to an Input Shaft/Spline 1st Path Output Pulley 7, which is rotationally fixed relative to an Input Intermediate Shaft/Spline 8. Also rotationally (but not necessarily axially) fixed on Input Intermediate Shaft/Spline 8 is an Input Cone 9. Input Cone 9 is coupled by a CVT Transmission Belt 10 to an Output Cone 11. Output Cone 11 is rotationally (but not necessarily axially) fixed to an Output Intermediate Shaft/Spline 12.

An Output Shaft/Spline 13 is slid onto Output Intermediate Shaft/Spline 12 so that it can rotate relative to Output Intermediate Shaft/Spline 12. So that Output Cone 11 is positioned so that it has a common axis of rotation with Output Shaft/Spline 13, but can freely rotate relative to Output Shaft/Spline 13.

And mounted on Output Shaft/Spline 13 is an Output Shaft/Spline 2nd Path Output Pulley 14. Output Shaft/Spline 2nd Path Output Pulley 14 is mounted so that it is axially fixed, but can freely rotate relative to relative to Output Shaft/Spline 13.

Output Cone 11 and Output Shaft/Spline 2nd Path Output Pulley 14 can be alternately rotationally fixed relative to Output Shaft/Spline 13 through the use of an Output Shaft/Spline Clutch 15A.

Output Shaft/Spline Clutch 15A can be used to either rotatably fix Output Shaft/Spline 2nd Path Output Pulley 14 or Output Cone 11 to Output Shaft/Spline 13, by shifting/sliding a Shift Sleeve 54. Unless Output Shaft/Spline 2nd Path Output Pulley 14 and Output Cone 11 are rotatably fixed to Output Shaft/Spline 13, they can freely rotate relative to Output Shaft/Spline 13.

For the 2nd Path of Extender 37, Input Shaft/Spline 2nd Path Input Pulley 4 is coupled by an Input Shaft/Spline 2nd Path Transmission Belt 16 to an Input Shaft/Spline 2nd Path Output Pulley 17, which is rotationally fixed relative to Output Intermediate Shaft/Spline 12. Also rotationally (but not necessarily axially) fixed on Output Intermediate Shaft/Spline 12 is a Output Cone 11.

And as described earlier, Output Cone 11 is coupled by a CVT Transmission Belt 10 to an Input Cone 9. Input Cone 9 is rotationally (but not necessarily axially) fixed to Input Intermediate Shaft/Spline 8. Also rotationally fixed to Input Intermediate Shaft/Spline 8 is an Output Shaft/Spline 2nd Path Input Pulley 18. Output Shaft/Spline 2nd Path Input Pulley 18 is coupled by an Output Shaft/Spline 2nd Path Transmission Belt 19 to Output Shaft/Spline 2nd Path Output Pulley 14.

Extender 37 has to two paths, Path 1 and Path 2. For Path 1, Input Shaft/Spline 1st Path Input Pulley 3 is fixed for rotation relative to Input Shaft/Spline 2 through the use of Input Shaft/Spline Clutch 5A, and Output Cone 11 is fixed for rotation relative to Output Shaft/Spline 13 through the use of Output Shaft/Spline Clutch 15A; so that power flows as follows: Input Shaft/Spline 2 to Input Shaft/Spline 1st Path Input Pulley 3 to Input Shaft/Spline 1st Path Transmission Belt 6 to Input Shaft/Spline 1st Path Output Pulley 7 to Input Intermediate Shaft/Spline 8 to Input Cone 9 to CVT Transmission Belt 10 to Output Cone 11 to Output Shaft/Spline 13 to Load Isolating Clutch 39 to Gearbox 38.

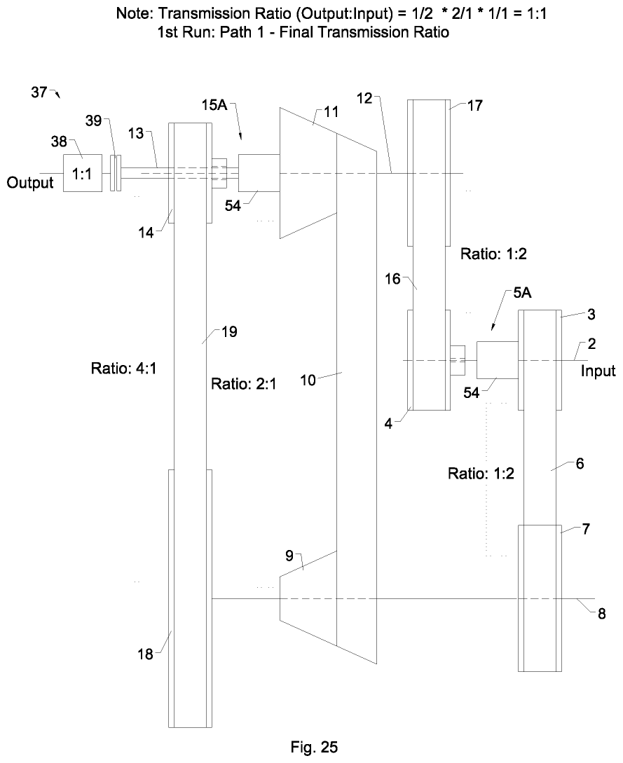

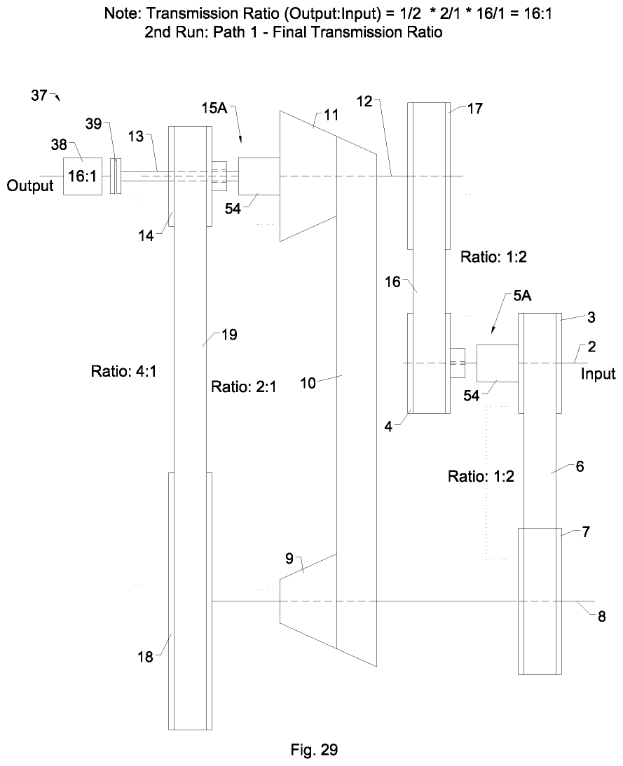

The 1st Run of Path 1 is shown in FIGS. 24 and 25; and the 2nd Run of Path 1 is shown in FIGS. 28 and 29.

For Path 2, Input Shaft/Spline 2nd Path Input Pulley 4 is fixed for rotation relative to Input Shaft/Spline 2 through the use of Input Shaft/Spline Clutch 5A, and Output Shaft/Spline 2nd Path Output Pulley 14 is fixed for rotation relative to Output Shaft/Spline 13 through the use of Output Shaft/Spline Clutch 15A; so that power flows as follows: Input Shaft/Spline 2 to Input Shaft/Spline 2nd Path Input Pulley 4 to Input Shaft/Spline 2nd Path Transmission Belt 16 to Input Shaft/Spline 2nd Path Output Pulley 17 to Output Intermediate Shaft/Spline 12 to Output Cone 11 to CVT Transmission Belt 10 to Input Cone 9 to Input Intermediate Shaft/Spline 8 to Output Shaft/Spline 2nd Path Input Pulley 18 to Output Shaft/Spline 2nd Path Transmission Belt 19 to Output Shaft/Spline 2nd Path Output Pulley 14 to Output Shaft/Spline 13 to Load Isolating Clutch 39 to Gearbox 38

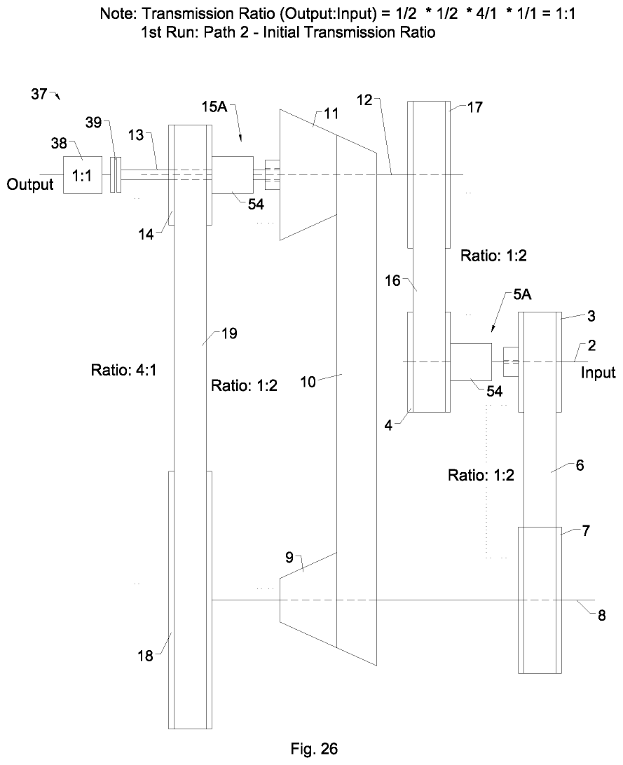

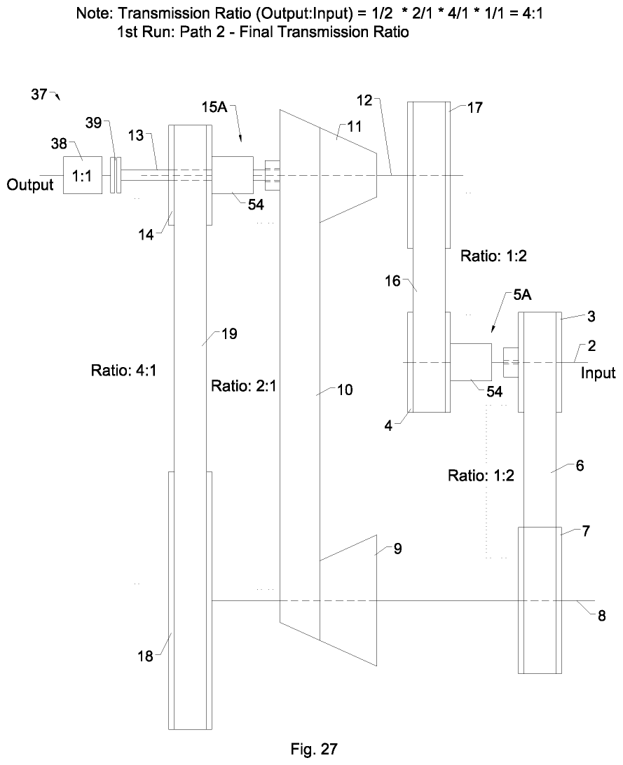

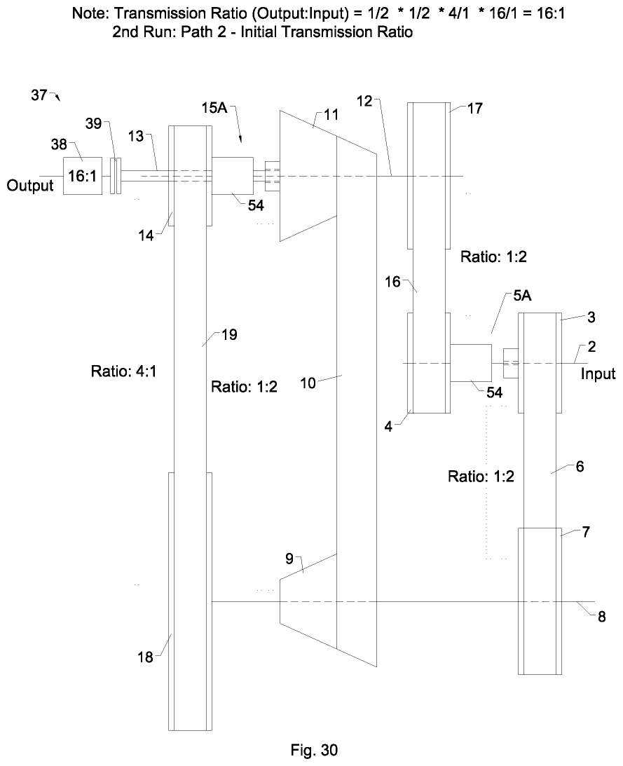

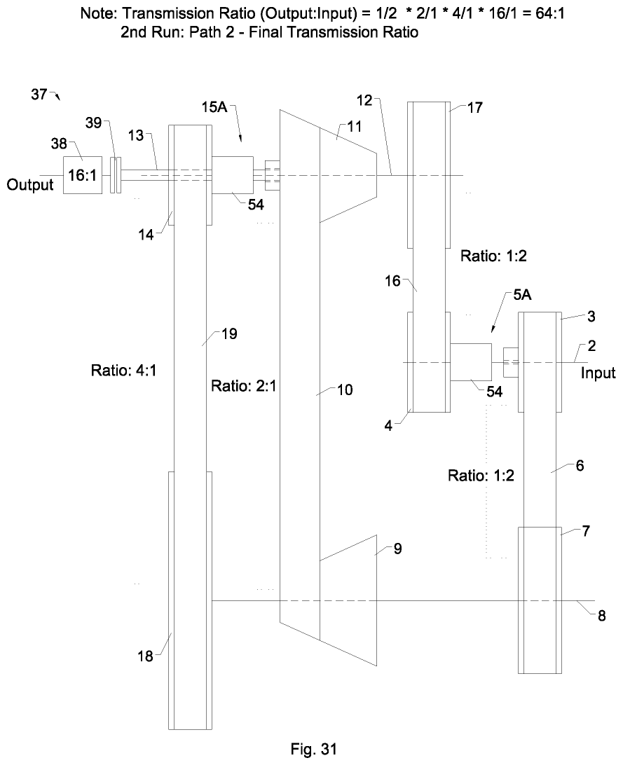

The 1st Run of Path 2 is shown in FIGS. 26 and 27; and the 2nd Run of Path 1 is shown in FIGS. 30 and 31.

The transmission ratio of Path 1 is changed from its Initial Transmission Ratio to its Final Transmission Ratio by relatively moving CVT Transmission Belt 10 from the “initial ends of Input Cone 9 and Output Cone 11 for Path 1” to the “final ends of Input Cone 9 and Output Cone 11 for Path 1”. The “initial ends and final ends of Input Cone 9 and Output Cone 11 for Path 1” can be arbitrarily chosen to be either “the left ends and right ends of Input Cone 9 and Output Cone 11”, or the “right ends and left ends of Input Cone 9 and Output Cone 11”.

And likewise, transmission ratio of Path 2 is changed from its Initial Transmission Ratio to its Final Transmission Ratio by relatively moving CVT Transmission Belt 10 from the “initial ends of Input Cone 9 and Output Cone 11 for Path 2” to the “final ends of Input Cone 9 and Output Cone 11 for Path 2”. The “initial ends and final ends of Input Cone 9 and Output Cone 11 for Path 2” are either “the left ends and right ends of Input Cone 9 and Output Cone 11”, or the “right ends and left ends of Input Cone 9 and Output Cone 11”; depending on the “initial ends and final ends of Input Cone 9 and Output Cone 11 for Path 1”, as described in the paragraph below.

CVT Transmission Belt 10 should be located at the same ends of Input Cone 9 and Output Cone 11 for the Final Transmission Ratio of Path 1 and the Initial Transmission Ratio of Path 2. So that the transmission ratio of Extender 37 can be un-abruptly changed when “Path 1 is changed to Path 2, and then the transmission ratio of Path 2 is changed from its Initial Transmission Ratio to its Final Transmission Ratio”; and also so that the transmission ratio of Extender 37 can be un-abruptly changed when “Path 2 is changed to Path 1, and then the transmission ratio of Path 1 is changed from its Final Transmission Ratio to its Initial Transmission Ratio”.

For example, as shown in FIGS. 24 to 31; for Path 1, the transmission ratio can be increased from its Initial Transmission Ratio to its Final Transmission Ratio by relatively moving CVT Transmission Belt 10 from the left-ends of Input Cone 9 and Output Cone 11 to the right-ends of Input Cone 9 and Output Cone 11. And when Path 1 is changed to Path 2, CVT Transmission Belt 10 is positioned at the right-ends of Input Cone 9 and Output Cone 11; so that for Path 2, the transmission ratio can be increased from its Initial Transmission Ratio to its Final Transmission Ratio by relatively moving CVT Transmission Belt 10 from the right-ends of Input Cone 9 and Output Cone 11 to the left-ends of Input Cone 9 and Output Cone 11.

The speed change ratios of Extender 37, which are: a) the speed change ratio of Input Shaft/Spline 1st Path Output Pulley 7 compared to Input Shaft/Spline 1st Path Input Pulley 3, b) the speed change ratio of Input Shaft/Spline 2nd Path Output Pulley 17 compared to Input Shaft/Spline 2nd Path Input Pulley 4, c) the speed change ratio of Output Shaft/Spline 2nd Path Output Pulley 14 compared to Output Shaft/Spline 2nd Path Input Pulley 18, and d) the speed change ratio of the CVT (which depends the axial position of CVT Transmission Belt 10 relative to Input Cone 9 and Output Cone 11); should be selected so that at the Final Transmission Ratio of Path 1 (see FIG. 25) and the Initial Transmission Ratio of Path 2 (see FIG. 26), the rotational speed of Input Shaft/Spline 1st Path Input Pulley 3 is identical to the rotational speed of Input Shaft/Spline 2nd Path Input Pulley 4, and the rotational speed of Output Cone 11 is identical to the rotational speed of Output Shaft/Spline 2nd Path Output Pulley 14. This will also ensure that the transmission ratio of Extender 37 when Path 1 is at its Final Transmission Ratio is identical to the transmission ratio of Extender 37 when Path 2 is at its Initial Transmission Ratio.

The configuration above, is identical to the configuration of Extender 1 of the prior art that was disclosed in U.S. Pat. No. 8,540,596. The extender of the prior art, like Extender 37, extends the transmission ratio range of a CVT as follows: like a regular CVT, the transmission ratio of Path 1 can be changed from its Initial Transmission Ratio to its Final Transmission Ratio (see FIGS. 24 and 25). Then the transmission ratio range can be extended by changing Path 1, which is at its Final Transmission Ratio (see FIG. 25), to Path 2, which is at its Initial Transmission Ratio (see FIG. 26). The speed change ratios of the extender (which is either Extender 1 or Extender 37) is selected so that the transmission ratio of the extender at the Initial Transmission Ratio of Path 2 (see FIG. 26) matches the transmission ratio of the extender at Final Transmission Ratio of Path 1 (see FIG. 25); and the transmission ratios from above the Initial Transmission Ratio of Path 2 (see FIG. 26) to the Final Transmission Ratio of Path 2 (see FIG. 27) is the transmission ratio range extension over a regular CVT.

In order the extend the transmission ratio range of Extender 1, Extender 37 uses a Gearbox 38. Gearbox 38 should be positioned directly or indirectly after Output Shaft/Spline 13.

The gear ratio of Gearbox 38 should be changed from a First Gear Ratio to a Second Gear Ratio before Path 2 is changed to Path 1 at the “Final Transmission Ratio of Path 2 (see FIG. 27)”. And the gear ratio of Gearbox 38 should be changed from the Second Gear Ratio to the First Gear Ratio before Path 1 is changed to Path 2 at the “Initial Transmission Ratio of Path 1 (see FIG. 28)”.

The First Gear Ratio and the Second Gear Ratio of Gearbox 38 should be selected so that when “Path 2 is changed to Path 1 at Final Transmission Ratio of Path 2 (see FIG. 27)”, the “transmission ratio of Extender 37 before Path 2 is changed to Path 1 (see FIG. 27)” is identical to the “transmission ratio of Extender 37 after Path 2 has been changed to Path 1 (see FIG. 28)”. And so that when “Path 1 is changed to Path 2 at Initial Transmission Ratio of Path 1 (see FIG. 28)”, the “transmission ratio of Extender 37 before Path 1 is changed to Path 2 (see FIG. 28)” is identical to the “transmission ratio of Extender 37 after Path 1 has been changed to Path 2 (see FIG. 27)”.

The “transmission ratio of Extender 37” is the ratio of “the output of Extender 37 (which is the output of Gearbox 38)” divided by “the input of Extender 37 (which is the input to Input Shaft/Spline 2)”.

When the “transmission ratio of Extender 37 before Path 2 is changed back to Path 1 (see FIG. 27)” is identical to “transmission ratio of Extender 37 after Path 2 is changed back to Path 1 (see FIG. 28)”, then the rotational speed of “the output of Gearbox 38 before Path 2 is changed to Path 1 at the Final Transmission Ratio of Path 2 (see FIG. 27)” is identical to the rotational speed of “the output of Gearbox 38 after Path 2 is changed to Path 1 at the Initial Transmission Ratio of Path 1 (see FIG. 28)”.

Gearbox 38 can have additional gear ratios to extend the transmission ratio further. Each additional transmission ratio of Gearbox 38 can be used extend the transmission ratio of Extender 1 by one path change of “Path 2 to Path 1 at the Final Transmission Ratio of Path 2” and one path change of “Path 1 to Path 2 at the Final Transmission Ratio of Path 1”.

The additional gear ratios should also be selected so that the rotational speed of “the output of Gearbox 38 before Path 2 is changed to Path 1 at the Final Transmission Ratio of Path 2 (see FIG. 27)” is identical to the rotational speed of “the output of Gearbox 38 after Path 2 is changed to Path 1 at the Initial Transmission Ratio of Path 1 (see FIG. 28)”.

Changing “Path 2 to Path 1” or “Path 1 to Path 2” is accomplished by changing the engagement of the Clutch Gears of Input Shaft/Spline Clutch 5A and Output Shaft/Spline Clutch 15A with their Shift Sleeve. When “Path 1 is changed to Path 2 at the Final Transmission Ratio of Path 1”, see FIG. 25 (configuration before path change) and FIG. 26 (configuration after path change); and when “Path 2 is changed to Path 1 at the Initial Transmission Ratio of Path 2”, see FIG. 26 (configuration before path change) and FIG. 25 (configuration after path change); the speed of the Clutch Gears on a common shaft/spline are equal. So that the speed of the “Clutch Gear that is about to be engaged with its Shift Sleeve” is equal to the speed of “its Shift Sleeve”. Note, Extender 1 of the prior art only allows “Path 1 to be changed to Path 2 at the Final Transmission Ratio of Path 1” and “Path 2 to be changed to Path 1 at the Initial Transmission Ratio of Path 2”.

And when “Path 2 is changed to Path 1 at the Final Transmission Ratio of Path 2”, see FIG. 27 (configuration before path change) and FIG. 28 (configuration after path change); and when “Path 1 is changed to Path 2 at the Initial Transmission Ratio of Path 1”, see FIG. 28 (configuration before path change) and FIG. 27 (configuration after path change); the speed of the Clutch Gears on a common shaft/spline are not equal. So that the speed of the “Clutch Gear that is about to be engaged with its Shift Sleeve” is different from the speed of “its Shift Sleeve”. For these situations, in order to reduce wear and allow for smoother shifting, Load Isolating Clutch 39 is disengaged before “Path 2 is changed to Path 1 at the Final Transmission Ratio of Path 2” and before “Path 1 is changed to Path 2 at the Initial Transmission Ratio of Path 1”. Load Isolating Clutch 39 is preferably positioned anywhere before Input Shaft/Spline 2 or anywhere after Output Shaft/Spline 13.

FIGS. 24 to 31 each show all speed change ratios of Extender 37, which are: a) the speed change ratio of Input Shaft/Spline 1st Path Output Pulley 7 compared to Input Shaft/Spline 1st Path Input Pulley 3; b) the speed change ratio of Input Shaft/Spline 2nd Path Output Pulley 17 compared to Input Shaft/Spline 2nd Path Input Pulley 4; c) the speed change ratio of Output Shaft/Spline 2nd Path Output Pulley 14 compared to Output Shaft/Spline 2nd Path Input Pulley 18; and d) the speed change ratio of the CVT.

And FIGS. 24 to 31 each also show the gear ratio of Gearbox 38; and provide a note for the “transmission ratio of Extender 37”, which in the note is referred to as Transmission Ratio.

The only purpose of the speed change ratios of Extender 37, the gear ratios of Gearbox 38″, and the “notes for the transmission ratios of Extender 37” shown in FIGS. 24 to 31 is to add clarity to the description. These values are examples only; many other values can be easily be derived from simple mathematics or trial-and-error experimentation. As such, these values should not limit the scope of the claims for this application.

When “Path 2 is changed to Path 1 at the Final Transmission Ratio of Path 2 (see FIG. 27)” or “Path 1 is changed to Path 2 at the Initial Transmission Ratio of Path 1 (see FIG. 28)”, the rotational speed of “Input Shaft/Spline 1st Path Input Pulley 3 and its Clutch Gear” is not identical to the rotational speed of “Input Shaft/Spline 2nd Path Input Pulley 4 and its Clutch Gear”, and the rotational speed of “Output Cone 11 and its Clutch Gear” is not identical to the rotational speed of “Output Shaft/Spline 2nd Path Output Pulley 14 and its Clutch Gear”. In order to account for this: a) Input Shaft/Spline Clutch 5A and Output Shaft/Spline Clutch 15A each use the clutch design of an Overlap Providing Clutch 56, which is different from the clutch design used for Input Shaft/Spline Clutch 5 and Output Shaft/Spline Clutch 15; and b) Load Isolating Clutch 39 disengages Extender 37 from either the output of Output Shaft/Spline 13 or the input to Input Shaft/Spline 2, before “Path 2 is changed to Path 1 at the Final Transmission Ratio of Path 2”, and before “Path 1 is changed to Path 2 at the Initial Transmission Ratio of Path 1”.

### Overlap Providing Clutch 56-Details

Details for Overlap Providing Clutch 56, which is the clutch design for Input Shaft/Spline Clutch 5A and Output Shaft/Spline Clutch 15A, is described in the paragraphs below.

When “Path 1 is changed to Path 2 at the Final Transmission Ratio of Path 1 (see FIGS. 25 and 29)” or “Path 2 is changed to Path 1 at the Initial Transmission Ratio of Path 2 (see FIGS. 26 and 30)”, the rotational speed of the Transmission Members on a common Transmission Shaft/Spline are identical, such that an overlap during shifting can be used. An overlap during shifting means that during shifting, for the Transmission Members mounted on a common Transmission Shaft/Spline; there is an instance where both “the Transmission Member to be disengaged” and “the Transmission Member to be engaged” are both engaged for torque transmission at the same time.

Transmission Members of the previous paragraph are either “Input Shaft/Spline 1st Path Input Pulley 3 and Input Shaft/Spline 2nd Path Input Pulley 4”, or “Output Cone 11 and Output Shaft/Spline 2nd Path Output Pulley 14”. And the Transmission Shaft/Spline of the previous paragraph is either Input Shaft/Spline 2 or Output Shaft/Spline 13.

When an overlap during shifting is used, no torque is being transmitting during the initial engagement of the Clutch Gear that is about to be engaged. This allows the Clutch Gear that is about to be engaged to rotationally align itself with its Shift Sleeve “before engagement”/“before it transmits torque”. As such, using an overlap during shifting allows for smoother shifting and less wear.

A clutch for which an overlap during shifting can be provided or removed as required is an Overlap Providing Clutch 56. For Overlap Providing Clutch 56, the distance between its Clutch Gears can be adjusted, so that an overlap during shifting can be provided or removed. When an overlap during shifting is provided, both Clutch Gears are engaged with their Shift Sleeve during shifting. When an overlap during shifting is not provided, only “one Clutch Gear at a time” is engaged with its Shift Sleeve during shifting.

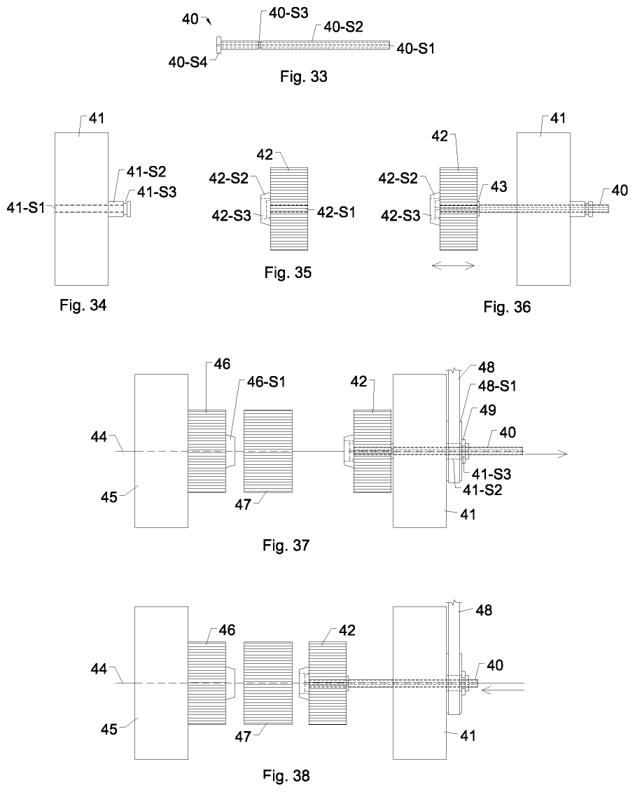

In order to adjust the distance between its Clutch Gears, the distance of at least on Clutch Gear relative to its Transmission Member needs to be adjust-able. For this purpose, Overlap Providing Clutch 56 has a Sliding Sleeve 40, see FIG. 33. Sliding Sleeve 40 is shaped like a spline that has: a) a Hole 40-S1, and b) External Circumferential Spline Teeth 40-S2. And in order to axially fix a Clutch Gear 42 to it, Sliding Sleeve 40 has an End Flange 40-S4 and a Locking Ring Groove 40-S3.

A Clutch Gear 42 is axially fixed to one end of Sliding Sleeve 40, see FIG. 36. This is achieved by sliding a centric Spline Hole 42-S1 of Clutch Gear 42 into Sliding Sleeve 40 until it engages with End Flange 40-S4. And in order to fix the axial position of Clutch Gear 42 relative to Sliding Sleeve 40, a Locking Ring 43 is inserted into Locking Ring Groove 40-S3.

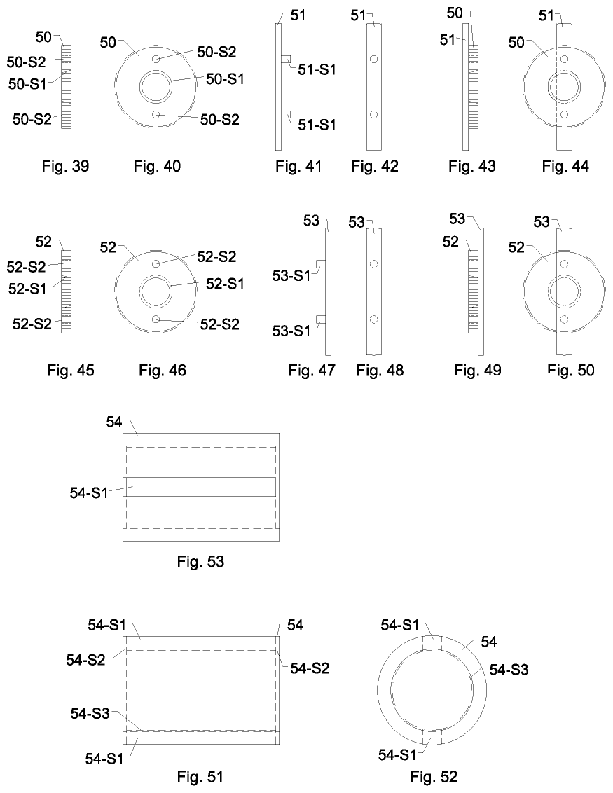

Clutch Gear 42 is shown by itself in FIG. 35. Spline Hole 42-S1 of Clutch Gear 42 has internal teeth that can engage with External Circumferential Spline Teeth 40-S2 of Sliding Sleeve 40; so that Clutch Gear 42 is also fixed for rotation relative to Sliding Sleeve 40 when it is inserted and axially secured to Sliding Sleeve 40. Additionally, Clutch Gear 42 has a Conical Surface 42-S2, which can engage with a Conical Surface Hole 50-S1 of a Blocker Ring 50 (see FIGS. 39 and 40). In order to avoid having End Flange 40-S4 of Sliding Sleeve 40 prevent Conical Surface 42-S1 from engaging with Conical Surface Hole 50-S1 of a Blocker Ring 50, Conical Surface 42-S2 has a Hole 42-S3 into which End Flange 40-S4 can be fully inserted.

The open end of Sliding Sleeve 40, which is the opposite end of the end on which Clutch Gear 42 is attached, is inserted into a centric Spline Hole 41-S1 of a Transmission Member 41 (see FIGS. 34 and 36).

Spline Hole 41-S1 of Transmission Member 41, which is shown in FIG. 34, has internal teeth that can engage with External Circumferential Spline Teeth 40-S2 of Sliding Sleeve 40; so that Sliding Sleeve 40 is fixed for rotation relative to Transmission Member 41 but can slide axially relative to Transmission Member 41. Because of this, Clutch Gear 42 can be slid towards-and-away from Transmission Member 41, but is fixed for rotation relative to Transmission Member 41 (see FIG. 36).

Transmission Member 41 is a means for conveying rotational energy, such as Input Shaft/Spline 1st Path Input Pulley 3, Input Shaft/Spline 2nd Path Input Pulley 4, Output Cone 11, or Output Shaft/Spline 2nd Path Output Pulley 14 (see FIGS. 24 to 31). Note, if Transmission Member 41 is Input Shaft/Spline 2nd Path Input Pulley 4 or Output Shaft/Spline 2nd Path Output Pulley 14, then the mirror image of the configuration shown in FIGS. 33 to 38 has to be used. Since for the configuration shown in FIGS. 33 to 38, Transmission Member 41 is positioned on the right side, while Input Shaft/Spline 2nd Path Input Pulley 4 and Output Shaft/Spline 2nd Path Output Pulley 14 are positioned on the left sides in FIGS. 24 to 31.

In order to fix or control the axial position of Transmission Member 41 relative to the frame of Extender 37, Transmission Member 41 has an Axial Position Controlling Sleeve 41-S2, which has Locking Ring Gap 41-S3 (see FIG. 34). When assembled (see FIG. 37); a Bearing 48-S1 of an Axial Position Controlling Plate 48 is slid into Axial Position Controlling Sleeve 41-S2; and then axially secured to Axial Position Controlling Sleeve 41-S2 using a Locking Ring 49, which is inserted into Locking Ring Gap 41-S3 of Axial Position Controlling Sleeve 41-S2. Bearing 48-S1 of Axial Position Controlling Plate 48 is used to reduce rotational friction; it can be removed if other methods for reducing rotational friction is/are used, such usage of lubrications, low friction surfaces, etc.

If Transmission Member 41 is Input Shaft/Spline 1st Path Input Pulley 3, Input Shaft/Spline 2nd Path Input Pulley 4, or Output Shaft/Spline 2nd Path Output Pulley 14; then the axial position of Axial Position Controlling Plate 48 is fixed relative to the frame of Extender 37, so that the axial position of Input Shaft/Spline 1st Path Input Pulley 3, Input Shaft/Spline 2nd Path Input Pulley 4, or Output Shaft/Spline 2nd Path Output Pulley 14 is fixed relative to the frame of Extender 37.

And if Transmission Member 41 is an Output Cone 11; then if desired, the axial position of Axial Position Controlling Plate 48, and as such also the axial position of Output Cone 11, can be controlled relative to the frame of Extender 37 based on the required transmission ratio of the CVT.

Alternately, the axial position of Axial Position Controlling Plate 48 can also be fixed relative to the frame of Extender 37, so that the axial position of Output Cone 11 is fixed relative to the frame of Extender 37. Since the transmission ratio of the CVT can also be changed by changing the axial position of CVT Transmission Belt 10.

FIG. 37 shows how assembled Sliding Sleeve 40 (shown in FIG. 36) and some other parts of Overlap Providing Clutch 56 are assembled on a Transmission Shaft/Spline 44. Here on Transmission Shaft/Spline 44 the following are mounted: a Transmission Member 45 that is fixed to a Clutch Gear 46; a Synchronizer Hub 47; and assembled Sliding Sleeve 40.

Clutch Gear 46 has a Conical Surface 46-S1 (see FIG. 37), which can engage with a Conical Surface Hole 52-S1 of a Blocker Ring 52 (see FIGS. 45 and 46). And assembled Sliding Sleeve 40 include Clutch Gear 42 and Transmission Member 41; which both are fixed for rotation relative to Sliding Sleeve 40, and such also fixed for rotation relative to each other.

Transmission Member 45, Clutch Gear 46, and assembled Sliding Sleeve 40 can freely rotate relative Transmission Shaft/Spline 44. While Synchronizer Hub 47 is fixed for rotation relative to Transmission Shaft/Spline 44.

Transmission Member 45 is a means for conveying rotational energy, such as Input Shaft/Spline 1st Path Input Pulley 3, Input Shaft/Spline 2nd Path Input Pulley 4, Output Cone 11, or Output Shaft/Spline 2nd Path Output Pulley 14 (see FIGS. 24 to 31). Note, if Transmission Member 45 is Input Shaft/Spline 1st Path Input Pulley 3 or Output Cone 11, then the mirror image of the configuration shown in FIGS. 33 to 38 has to be used. Since for the configuration shown in FIGS. 33 to 38, Transmission Member 45 is positioned on the left side, while Input Shaft/Spline 1st Path Input Pulley 3 and Output Cone 11 are positioned on the right sides in FIGS. 24 to 31.

And Transmission Shaft/Spline 44 is a shaft or spline on which Input Shaft/Spline Clutch 5A and its Transmission Members are mounted, such as Input Shaft/Spline 2; or a shaft or spline on which Output Shaft/Spline Clutch 15A and its Transmission Members are mounted, such as Output Shaft/Spline 13 (see FIGS. 24 to 31).

“Transmission Member 45 and Clutch Gear 46” and Synchronizer Hub 47 are mounted so that they are axially fixed relative to Transmission Shaft/Spline 44. Transmission Member 45 and Clutch Gear 46 are axially fixed relative to each other, and can be directly axially fixed to Transmission Shaft/Spline 44, such as by attaching axial position maintaining surfaces to Transmission Shaft/Spline 44, such as locking rings for example. Or alternately Transmission Member 45 can be axially fixed relative to Transmission Shaft/Spline 44 by using the method used to axially fix Transmission Member 41 relative to the frame of Extender 37, which will also axially fix it relative to Transmission Shaft/Spline 44.

And the axial position of Clutch Gear 42 (which is controlled through Sliding Sleeve 40) is controlled so that it has two fixed axial positions relative to Synchronizer Hub 47. The first axial position is the extended axial position, which is when Clutch Gear 42 is extended. And the second axial position is the retracted axial position, which is when Clutch Gear 42 is retracted. The extended axial position is used to provide an overlap during shifting; and the retracted axial position is used to remove an overlap during shifting.

FIG. 38 shows the same assembly of FIG. 37; but while for FIG. 37, Clutch Gear 42 is retracted; in FIG. 38, Clutch Gear 42 is extended. Clutch Gear 42 is retracted by pulling Sliding Sleeve 40 away from Synchronizer Hub 47 (see FIG. 37); and Clutch Gear 42 is extended by pushing Sliding Sleeve 40 towards Synchronizer Hub 47 (see FIG. 38).

A Blocker Ring 50 is shown in FIGS. 39 and 40, it has a centric Conical Surface Hole 50-S1 and two Stud Holes 50-S2. FIGS. 41 and 42 show a Pusher Plate 51, which has two Studs 51-S1 which can each tightly fit into a Stud Hole 50-S2 of Blocker Ring 50.

Pusher Plate 51 is fixed to Blocker Ring 50 by pressing in Studs 51-S1 into Stud Holes 50-S2 (see FIGS. 43 and 44). Note: The teeth of Blocker Ring 50 are not accurately shown, but only shown as a dash-dot line because of time constraints.

The width of Pusher Plate 51 should be slightly narrower than the width of Cuts 54-S1 of Shift Sleeve 54; with dimensions such that Pusher Plate 51 can slightly rotate relative to Shift Sleeve 54 until the teeth of Blocker Ring 50 are misaligned with the teeth of Shift Sleeve 54; so that during engagement, a torque due to a large difference in speed between Clutch Gear 42 and Blocker Ring 50 provides resistance to shifting; and with dimensions such that when said torque has been sufficiently reduced, then pushing Blocker Ring 50 against Shift Sleeve 54 will align the teeth of Blocker Ring 50 with the teeth of Shift Sleeve 54, so that Blocker Ring 50 can be pushed into Shift Sleeve 54. This should be obvious based on the information available for Blocker Rings used in Synchromesh Transmissions.

A Blocker Ring 52 is shown in FIGS. 45 and 46, it has a centric Conical Surface Hole 52-S1 and two Stud Holes 52-S2. FIGS. 47 and 48 show a Pusher Plate 53, which has two Studs 53-S1 which can each tightly fit into a Stud Hole 52-S2 of Blocker Ring 52.

Pusher Plate 53 is fixed to Blocker Ring 52 by pressing in Studs 53-S1 into Stud Holes 53-S2 (see FIGS. 49 and 50). Note: The teeth of Blocker Ring 52 are not accurately shown, but only shown as a dash-dot line because of time constraints.

The width of Pusher Plate 53 should be slightly narrower than the width of Cuts 54-S1 of Shift Sleeve 54; with dimension such that Pusher Plate 53 can slightly rotate relative to Shift Sleeve 54 until the teeth of Blocker Ring 52 are misaligned with the teeth of Shift Sleeve 54; so that during engagement, a torque due to a large difference in speed between Clutch Gear 46 and Blocker Ring 52 provides resistance to shifting; and with dimensions such that when said torque has sufficiently been reduced, then pushing Blocker Ring 52 against Shift Sleeve 54 will align the teeth of Blocker Ring 52 with the teeth of Shift Sleeve 54, so that Blocker Ring 52 can be pushed into Shift Sleeve 54. This should be obvious based on the information available for Blocker Rings used in Synchromesh Transmissions.

FIGS. 51 to 53 show a Shift Sleeve 54. Shift Sleeve 54 is a sleeve that has Internal Teeth 54-S3 that can engage with the teeth of Clutch Gear 42, the teeth of Blocker Ring 50, the teeth of Synchronizer Hub 47, the teeth of Clutch Gear 46, and the teeth of Blocker Ring 52.

Shift Sleeve 54 has two diametrically oppositely positioned Cuts 54-S1, which are for the surfaces of Pusher Plate 51 and Pusher Plate 53 that extend beyond the outer circumferential surface of Shift Sleeve 54. Cuts 54-S1 allow Pusher Plate 51 and Pusher Plate 53 to slide lengthwise relative of Shift Sleeve 54.

If necessary, the open ends of Shift Sleeve 54 can have an Internal Rim 54-S2 that does not have any internal teeth. The purpose of Internal Rims 54-S2 is to avoid having Internal Teeth 54-S3 of Shift Sleeve 54 preventing Blocker Ring 50 and Blocker Ring 52 from rotating relative to Shift Sleeve 54 when they are fully pushed outwards of Shift Sleeve 54. Since the teeth of the Blocker Rings should be slightly misaligned with the teeth of Shift Sleeve 54 during initial engagement due to the rotational torque applied on them.

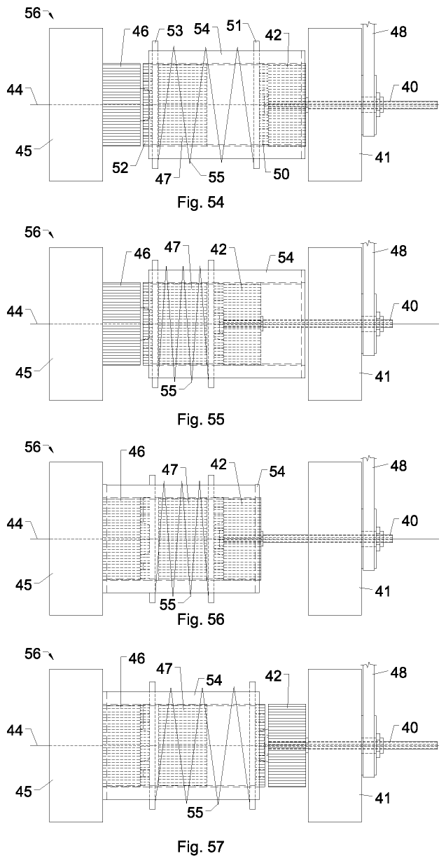

The width Shift Sleeve 54 should be selected so that: a) when Clutch Gear 42 is retracted; it can either engage/couple Synchronizer Hub 54 with Clutch Gear 42 (see FIG. 54), or engage/couple Synchronizer Hub 54 with Clutch Gear 46 (see FIG. 57). And so that: b) when Clutch Gear 42 is extended; it can engage/couple Synchronizer Hub (47) with both Clutch Gear 46 and Clutch Gear 42 (see FIG. 56).

FIG. 54 shows an Overlap Providing Clutch 56. Overlap Providing Clutch 56 comprises of a Transmission Shaft/Spline 44 on which the following are mounted: Transmission Member 45 that is fixed to Clutch Gear 46; Blocker Ring 52; Synchronizer Hub 47; Blocker Ring 50; an assembled Sliding Sleeve 40, which include Clutch Gear 42 and Transmission Member 41; and an Axial Position Controlling Plate 48 that is used to fix or control the axial position of Transmission Member 41.

And Overlap Providing Clutch 56 also comprises of Shift Sleeve 54, into which Blocker Ring 52, Synchronizer Hub 47, and Blocker Ring 50 are slid into. And once Blocker Ring 52, Synchronizer Hub 47, and Blocker Ring 50 have been slid into Shift Sleeve 54; Pusher Plate 53 is securely attached to Blocker Ring 52, and Pusher Plate 53 is securely attached to Blocker Ring 52.

And Overlap Providing Clutch 56 also comprises of Shift Sleeve 54, into which Blocker Ring 52, Synchronizer Hub 47, and Blocker Ring 50 are slid into. Prior to sliding Blocker Ring 52, Synchronizer Hub 47, and Blocker Ring 50 into Shift Sleeve 54, a Spring 55 is slid onto Shift Sleeve 54.

And once Blocker Ring 52, Synchronizer Hub 47, and Blocker Ring 50 have been slid into Shift Sleeve 54; Pusher Plate 53 and Pusher Plate 51 are positioned at the ends of Spring 55, and Pusher Plate 53 is securely attached to Blocker Ring 52 and Pusher Plate 53 is securely attached to Blocker Ring 52. So that Spring 55 is positioned between Pusher Plate 53 of Blocker Ring 52 and Pusher Plate 51 of Blocker Ring 50; and so that Spring 55 pushes Blocker Ring 50 and Blocker Ring 52 toward their open ends of Shift Sleeve 54 (see FIG. 54).

Shift Sleeve 54 is used to alternately engage Transmission Member 45 or Transmission Member 41 for torque transmission. This is achieved by sliding Shift Sleeve 54 to the right, so that it couples Clutch Gear 42 with Synchronizer Hub 47 (see FIGS. 54 and 55); and by sliding Shift Sleeve 54 to the left, so that it couples Clutch Gear 46 with Synchronizer Hub 47 (see FIG. 57).

### Overlap Providing Clutch 56—When to Provide Overlap

When “Path 1 is changed to Path 2 at the Final Transmission Ratio of Path 1” or “Path 2 is changed to Path 1 at the Initial Transmission Ratio of Path 2”, Clutch Gear 42 should be extended, so that there is some overlap during path changes, see FIGS. 55 and 56. After path changing has been completed, Clutch Gear 42 should be immediately retracted, so as to remove the overlap, see FIG. 57. This is because the speed of “Transmission Member 45 and Clutch Gear 46” and “Transmission Member 41 and Clutch Gear 42” only match at the Final Transmission Ratio of Path 1 and the Initial Transmission Ratio of Path 2.

And when “Path 1 is changed to Path 2 at the Initial Transmission Ratio of Path 1” or “Path 2 is changed to Path 1 at the Final Transmission Ratio of Path 2”, it is recommended that Clutch Gear 46 is retracted, so that there is no overlap during path changes, see FIGS. 54 and 57.

But if desired an overlap can be provided when “Path 1 is changed to Path 2 at the Initial Transmission Ratio of Path 1” or “Path 2 is changed to Path 1 at the Final Transmission Ratio of Path 2”. Since when “Path 1 is changed to Path 2 at the Initial Transmission Ratio of Path 1”, or “Path 2 is changed to Path 1 at the Final Transmission Ratio of Path 2”, Load Isolating Clutch 39 is disengaged, so that Clutch Gear 42 and Clutch Gear 46 can freely rotate relative to each other. But the overlap should be removed before Load Isolating Clutch 39 is engaged.

### Overall Shifting Procedure—Extender 37

Changing “Path 1 to Path 2 at the Final Transmission Ratio of Path 1”, and changing “Path 2 to Path 1 at the Initial Transmission Ratio of Path 2”; is accomplish by shifting the Shift Sleeves 54 of Input Shaft/Spline Clutch 5A and Output Shaft/Spline Clutch 15A as shown in FIGS. 25 and 26, and FIGS. 29 and 30.

And described in the paragraphs below are the procedures to change “Path 2 to Path 1 at the Final Transmission Ratio of Path 2”, see FIG. 27 (configuration before path change) and FIG. 28 (configuration after path change); and to change “Path 1 to Path 2 at the Initial Transmission Ratio of Path 1, see FIG. 28 (configuration before path change) and FIG. 27 (configuration after path change). The prior art does not allow: a) changing “Path 2 to Path 1 at the Final Transmission Ratio of Path 2”, and b) changing “Path 1 to Path 2 at the Initial Transmission Ratio of Path 1”; since the procedures described below are required in order to allow these path changes.

The procedure to change “Path 2 to Path 1 at the Final Transmission Ratio of Path 2” is as follows: a) Load Isolating Clutch 39 is disengaged; b) Shift Sleeve 54 of Input Shaft/Spline Clutch 5A and Shift Sleeve 54 of Output Shaft/Spline Clutch 15A are moved from the configuration shown in FIG. 27 to the configuration shown in FIG. 28, and Gearbox 38 is moved to a transmission ratio that is selected such that the “transmission ratio of Extender 37 before Path 2 is changed to Path 1 (see FIG. 27)” is identical to the “transmission ratio of Extender 37 after Path 2 is changed to Path 1 (see FIG. 28)”; and c) Load Isolating Clutch 39 is engaged.

The procedure to change “Path 1 to Path 2 at the Initial Transmission Ratio of Path 1” is as follows: a) Load Isolating Clutch 39 is disengaged; b) Shift Sleeve 54 of Input Shaft/Spline Clutch 5A and Shift Sleeve 54 of Output Shaft/Spline Clutch 15A are moved from the configuration shown in FIG. 28 to the configuration shown in FIG. 27, and Gearbox 38 is moved to a transmission ratio that is selected such that the “transmission ratio of Extender 37 before Path 1 is changed to Path 2 (see FIG. 28)” is identical to the “transmission ratio of Extender 37 after Path 1 is changed to Path 2 (see FIG. 27)”; and c) Load Isolating Clutch 39 is engaged.

### Overlap Providing Clutch 56 Shifting Procedure

For the Overall Shifting Procedure of the previous sections, Item b) refers to moving/shifting Shift Sleeve 54 of Input Shaft/Spline Clutch 5A and Shift Sleeve 54 of Output Shaft/Spline Clutch 15A. Additional details for moving/shifting the Shift Sleeves 54 are provided in this section.

When “Path 1 is changed to Path 2 at the Final Transmission Ratio of Path 1 (see FIG. 25 to FIG. 26 and FIGS. 29 to 30)” shifting of Input Shaft/Spline Clutch 5A and Output Shaft/Spline Clutch 15A, which each are an Overlap Providing Clutch 56, should each follow these steps: a) Initially Shift Sleeve 54 is engaged with Clutch Gear 42 (see FIG. 54); b) Sliding Sleeve 40 is pushed towards Synchronizer Hub 47, so that Clutch Gear 42 is extended so that there will be an overlap during shifting (see FIG. 55); c) Shift Sleeve 54 is shifted from Clutch Gear 42 towards Clutch Gear 46 (see FIG. 56); d) Sliding Sleeve 40 is pulled away from Synchronizer Hub 47, so that Clutch Gear 42 is retracted so as to remove the overlap (see FIG. 57).

And when “Path 2 is changed to Path 1 at the Initial Transmission Ratio of Path 2 (see FIG. 26 to FIG. 25 and FIGS. 30 to 29)” shifting of Input Shaft/Spline Clutch 5A and Output Shaft/Spline Clutch 15A, which each are an Overlap Providing Clutch 56, can should follow these steps: a) Initially Shift Sleeve 54 is engaged with Clutch Gear 46 (see FIG. 57); b) Sliding Sleeve 21 is pushed towards Synchronizer Hub 47, so that Clutch Gear 42 is extended so that there will be overlap during shifting (see FIG. 56); c) Shift Sleeve 54 is shifted from Clutch Gear 46 towards Clutch Gear 42 (see FIG. 55); d) Sliding Sleeve 40 is pulled away from Synchronizer Hub 47, so that Clutch Gear 42 is retracted so as to remove the overlap (see FIG. 54).

Alternatively, the steps in the following paragraphs can be used during shifting of “Path 1 to Path 2 at the Final Transmission Ratio of Path 1” and during shifting of “Path 2 to Path 1 at the Initial Transmission Ratio of Path 2”.

For the alternate steps, when “Path 1 is changed to Path 2 at the Final Transmission Ratio of Path 1” shifting of Input Shaft/Spline Clutch 5A and Output Shaft/Spline Clutch 15A, which each are an Overlap Providing Clutch 56, should each follow these steps: a) Initially Shift Sleeve 54 is engaged with Clutch Gear 42, which is extended (see FIG. 55); b) Shift Sleeve 54 is shifted from Clutch Gear 42 towards Clutch Gear 46 (see FIG. 56); d) Sliding Sleeve 40 is pulled away from Synchronizer Hub 47, so that Clutch Gear 42 is retracted so as to remove the overlap (see FIG. 57).

And for the alternate steps, when “Path 2 is changed to Path 1 at the Initial Transmission Ratio of Path 2” shifting of Input Shaft/Spline Clutch 5A and Output Shaft/Spline Clutch 15A, which each are an Overlap Providing Clutch 56, should each follow these steps: a) Initially Shift Sleeve 54 is engaged with Clutch Gear 46 (see FIG. 57); b) Sliding Sleeve 40 is pushed towards Synchronizer Hub 47, so that Clutch Gear 42 is extended so that there will be overlap during shifting (see FIG. 56); c) Shift Sleeve 54 is shifted from Clutch Gear 46 towards Clutch Gear 42 (see FIG. 55).

When “Path 2 is changed to Path 1 at the Final Transmission Ratio of Path 2 (see FIG. 27 to FIG. 28)” shifting of Input Shaft/Spline Clutch 5A and Output Shaft/Spline Clutch 15A, which each are an Overlap Providing Clutch 56, should each follow these steps: a) Initially Shift Sleeve 54 is engaged with Clutch Gear 46 (see FIG. 56 or 57); b) If Sliding Sleeve 40 is extended (see FIG. 56), it should be retracted (see FIG. 57); and if Sliding Sleeve 40 is retracted (see FIG. 57), it should be left retracted (see FIG. 57); c) Shift Sleeve 54 is shifted from Clutch Gear 46 towards Clutch Gear 42 (see FIG. 54).

When “Path 1 is changed to Path 2 at the Initial Transmission Ratio of Path 1 (see FIG. 28 to FIG. 27)” shifting of Input Shaft/Spline Clutch 5A and Output Shaft/Spline Clutch 15A, which each are an Overlap Providing Clutch 56, should each follow these steps: a) Initially Shift Sleeve 54 is engaged with Clutch Gear 42 (see FIG. 54 or 55); b) If Sliding Sleeve 40 is extended (see FIG. 55), it should be retracted (see FIG. 54); and if Sliding Sleeve 40 is retracted (see FIG. 54), it should be left retracted (see FIG. 54); c) Shift Sleeve 54 is shifted from Clutch Gear 42 towards Clutch Gear 46 (see FIG. 57).

Additionally, when “Path 1 is changed to Path 2 at the Final Transmission Ratio of Path 1” by shifting Shift Sleeves 54 of Input Shaft/Spline Clutch 5A and Output Shaft/Spline Clutch 15A from the positions shown in FIG. 25 to the positions shown in FIG. 26, and when “Path 2 is changed to Path 1 at the Initial Transmission Ratio of Path 2” by shifting Shift Sleeves 54 of Input Shaft/Spline Clutch 5A and Output Shaft/Spline Clutch 15A from the positions shown in FIG. 26 to the positions shown in FIG. 25; it is recommended that one Shift Sleeve 54 is shifted and engaged before the other.

For the previous paragraph, if one Shift Sleeve 54 is shifted and engaged before the other, there is absolutely no torque being transmitted by the clutch of the “first Shift Sleeve 54 to be engaged”. So that no torque is being transmitted during the during the initial engagement of the “first Shift Sleeve 54 to be engaged” with the “first Clutch Gear to be engaged”; which teeth can be misaligned relative to each other prior to engagement. This is because the Clutch Gear that is about to be engaged of the other clutch, which is coupled/bound to the “first Clutch Gear to be engaged” (through belts, etc.) can freely rotate.

Engaging the “first Shift Sleeve 54 to be engaged” with the “first Clutch Gear to be engaged”, will align the teeth of the other Clutch Gear that is about to be engaged with its Shift Sleeve 54. So that when the other Shift Sleeve 54 is engaged so that torque is being partially transmitted by its clutch, the teeth of both of its Clutch Gears are already aligned or almost aligned. Here the Shift Sleeve 54 of Input Shaft/Spline Clutch 5A can be shifted and engaged first, before the Shift Sleeve 54 of Output Shaft/Spline Clutch 15A is shifted and engaged; or alternately, the Shift Sleeve 54 of Input Shaft/Spline Clutch 5A can be shifted and engaged first, before the Shift Sleeve 54 of Output Shaft/Spline Clutch 15A is shifted and engaged.

### Overlap Providing Clutch With Neutral

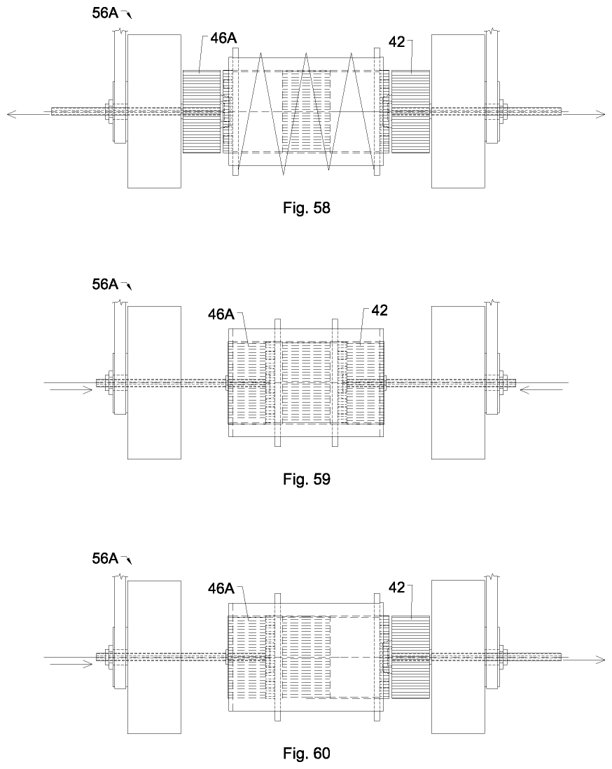

FIGS. 58 to 60 show an Overlap Providing Clutch 56A that can be used instead of Overlap Providing Clutch 56 for Input Shaft/Spline Clutch 5A and/or Output Shaft/Spline Clutch 15A. Overlap Providing Clutch 56A is identical to Overlap Providing Clutch 56, except that both of its Clutch Gears can be extended and retracted. The Clutch Gears of Overlap Providing Clutch 56A are labeled as Clutch Gear 46A and Clutch Gear 42.

The function of Overlap Providing Clutch 56A is identical to Overlap Providing Clutch 56, except that it has a Neutral Configuration. The Neutral Configuration is obtained by retracting both, Clutch Gear 46A and Clutch Gear 42, see FIG. 58.

For all other operations one Clutch Gear should be extended while the other Clutch Gear is extended and retracted in the same manner as described for Overlap Providing Clutch 56, see FIGS. 59 and 60.

When the clutch design for one or both of Input Shaft/Spline Clutch 5A and/or Output Shaft/Spline Clutch 15A are an Overlap Providing Clutch 56A instead of an Overlap Providing Clutch 56, a Neutral Transmission can be obtained through the Overlap Providing Clutch(es) 56A. So that Load Isolating Clutch 39 is not needed; since the only purpose of disengaging Load Isolating Clutch 39 is to provide a Neutral Transmission.

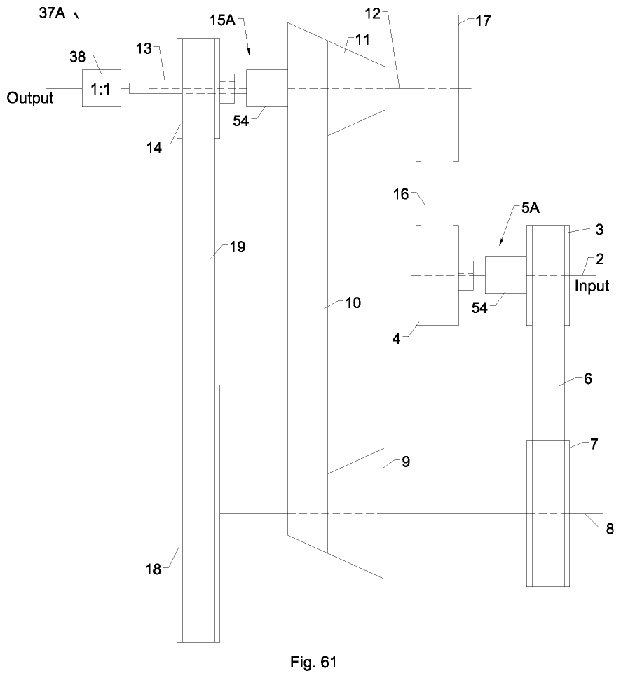

FIG. 61 shows an alternate embodiment of Extender 37, which is labeled as Extender 37A. Extender 37A does not use a Load Isolating Clutch 39, since for Extender 37A one or both of Input Shaft/Spline Clutch 5A and/or Output Shaft/Spline Clutch 15A are an Overlap Providing Clutch 56A instead of an Overlap Providing Clutch 56.

### Preferred Embodiment of the Invention (Best Mode)

The preferred embodiment of the invention is an Extender 37 which is described in the “Second Embodiment—Preferred Embodiment for an Extender” of this disclosure.

### CONCLUSION, RAMIFICATIONS, AND SCOPE

While my above description contains many specificities, these should not be construed as limitations on the scope, but rather as an exemplification of one or several embodiment(s) thereof. Many other variations are possible.

Accordingly, the scope should be determined not by the embodiment(s) illustrated, but by the appended claims and their legal equivalents.

I claim:

1. An Extender (37) for extending the transmission ratio shifting range of a CVT, of an extender of prior art by allowing the entire transmission ratio shifting range of an extender of prior art to be repeated at a higher transmission ratio; said Extender (37) and said extender of prior art both comprise of the following:
a) an Input Shaft/Spline (2) to which an Input Shaft/Spline 1st Path Input Pulley (3) and an Input Shaft/Spline 2nd Path Input Pulley (4) are mounted so that they are axially fixed relative to said Input Shaft/Spline (2), but can freely rotate on relative to said Input Shaft/Spline (2);
b) an Input Shaft/Spline Clutch (5A), which can be used to alternately rotationally fix said Input Shaft/Spline 1st Path Input Pulley (3) or said Input Shaft/Spline 2nd Path Input Pulley (4) to said Input Shaft/Spline (2);
c) an Input Intermediate Shaft/Spline (8) to which an Input Shaft/Spline 1st Path Output Pulley (7), an Input Cone (9), and an Output Shaft/Spline 2nd Path Input Pulley (18) are mounted so that they rotatably fixed relative to Input Intermediate Shaft/Spline (8);
d) an Output Intermediate Shaft/Spline (12) to which an Input Shaft/Spline 2nd Path Output Pulley (17), and an Output Cone (11) are mounted so that they rotatably fixed relative to Output Intermediate Shaft/Spline (12);
e) an Output Shaft/Spline (13) to which an Output Shaft/Spline 2nd Path Output Pulley (14) is mounted so that it is axially fixed but can freely rotate relative to relative to said Output Shaft/Spline (13); and
said Output Cone (11) is positioned so that it has a common axis of rotation with Output Shaft/Spline (13), but can freely rotate relative to Output Shaft/Spline 13;
f) an Output Shaft/Spline Clutch (15A), which can be used to alternately rotationally fix said Output Shaft/Spline 2nd Path Output Pulley (14) or said Output Cone (11) to said Output Shaft/Spline (13),
g) an Input Shaft/Spline 1st Path Transmission Belt (6) for coupling said Input Shaft/Spline 1st Path Input Pulley (3) to said Input Shaft/Spline 1st Path Output Pulley (7);
h) an Input Shaft/Spline 2nd Path Transmission Belt (16) for coupling said Input Shaft/Spline 2nd Path Input Pulley (4) to said Input Shaft/Spline 2nd Path Output Pulley (17);
i) a CVT Transmission Belt (10) for coupling said Input Cone (9) to said Output Cone (11);
j) an Output Shaft/Spline 2nd Path Transmission Belt (19) for coupling said Output Shaft/Spline 2nd Path Input Pulley (18) to said Output Shaft/Spline 2nd Path Output Pulley (14);
said Extender (37) has to two paths, Path 1 and Path 2;
for Path 1, said Input Shaft/Spline Clutch (5A) is engaged with said Input Shaft/Spline 1st Path Input Pulley (3), and said Output Shaft/Spline Clutch (15A) is engaged with said Output Cone (11); so that power flows as follows: said Input Shaft/Spline (2) to said Input Shaft/Spline 1st Path Input Pulley (3) to said Input Shaft/Spline 1st Path Transmission Belt (6) to said Input Shaft/Spline 1st Path Output Pulley (7) to said Input Intermediate Shaft/Spline (8) to said Input Cone (9) to said CVT Transmission Belt (10) to said Output Cone (11) to said Output Intermediate Shaft/Spline (12) to said Output Shaft/Spline (13);
for Path 2, said Input Shaft/Spline Clutch (5A) is engaged with said Input Shaft/Spline 2nd Path Input Pulley (4), and said Output Shaft/Spline Clutch (15A) is engaged with said Output Shaft/Spline 2nd Path Output Pulley (14); so that power flows as follows: said Input Shaft/Spline (2) to said Input Shaft/Spline 2nd Path Input Pulley (4) to said Input Shaft/Spline 2nd Path Transmission Belt (16) to said Input Shaft/Spline 2nd Path Output Pulley (17) to said Output Intermediate Shaft/Spline (12) to said Output Cone (11) to said CVT Transmission Belt (10) to said Input Cone (9) to said Input Intermediate Shaft/Spline (8) to said Output Shaft/Spline 2nd Path Input Pulley (18) to said Output Shaft/Spline 2nd Path Transmission Belt (19) to said Output Shaft/Spline 2nd Path Output Pulley (14) to said Output Shaft/Spline (13);
a transmission ratio of Path 1 is changed from an Initial Transmission Ratio to a Final Transmission Ratio by relatively moving said CVT Transmission Belt (10) from the initial ends of said Input Cone (9) and said Output Cone (11) to the final ends of said Input Cone (9) and said Output Cone (11) for Path 1;
and a transmission ratio of Path 2 is changed from an Initial Transmission Ratio to a Final Transmission Ratio by relatively moving said CVT Transmission Belt (10) from the initial ends of said Input Cone (9) and said Output Cone (11) to the final ends of said Input Cone (9) and said Output Cone (11) for Path 2;
said CVT Transmission Belt (10) should be located at the same ends of said Input Cone (9) and said Output Cone (11) for the Final Transmission Ratio of Path 1 and the Initial Transmission Ratio of Path 2;
the speed change ratios of said Extender (37), which are the speed change ratio of said Input Shaft/Spline 1st Path Output Pulley (7) compared to said Input Shaft/Spline 1st Path Input Pulley (3); the speed change ratio of said Input Shaft/Spline 2nd Path Output Pulley (17) compared to said Input Shaft/Spline 2nd Path Input Pulley (4); the speed change ratio of said Output Shaft/Spline 2nd Path Output Pulley (14) compared to said Output Shaft/Spline 2nd Path Input Pulley (18);
and the speed change ratio of said CVT, which depends the axial position of said CVT Transmission Belt (10) relative said Input Cone (9) and said Output Cone (11); should be selected so that at the Final Transmission Ratio of Path 1, the rotational speed of said Input Shaft/Spline 1st Path Input Pulley (3) is identical to the rotational speed of said Input Shaft/Spline 2nd Path Input Pulley (4), and the rotational speed of said Output Cone (11) is identical to the rotational speed of said Output Shaft/Spline 2nd Path Output Pulley (14); this will also ensure that the transmission ratio of said Extender (37) when Path 1 is at its Final Transmission Ratio is identical to the transmission ratio of said Extender (37) when Path 2 is at its Initial Transmission Ratio;
like said extender of the prior art, said Extender (37) extends the transmission ratio range of said CVT as follows; like a regular CVT, the transmission ratio of Path 1 can be changed from its Initial Transmission Ratio to its Final Transmission Ratio; then the transmission ratio range can be extended by changing Path 1, which is at its Final Transmission Ratio, to Path 2, which is at its Initial Transmission Ratio; the speed change ratios of said Extender (36) are selected so that the transmission ratio of said Extender (37) at the Initial Transmission Ratio of Path 2 matches the transmission ratio of said Extender (37) at Final Transmission Ratio of Path 1; and the transmission ratios from above the Initial Transmission Ratio of Path 2 to the Final Transmission Ratio of Path 2 is the transmission ratio range extension over a regular CVT;
the entire Transmission Ratio Shifting Range of said extender of the prior art is referred to as a 1st Run for Extender (37); and Extender (37) repeats the entire Transmission Ratio Shifting Range of the 1st Run at the higher transmission ratio, which is referred to as its 2nd Run; so as to provide additional transmission ratio;
the 1st Run of said Extender (37) comprises of the following ranges, the Initial Transmission Ratio to the Final Transmission Ratio of Path 1; and the Initial Transmission Ratio to the Final Transmission Ratio of Path 2;
in order to allow for the 2nd Run, Extender 37 allows the following over the prior art, once Path 2 has reached its Final Transmission Ratio, it can be changed to back to Path 1 which is at its Initial Transmission Ratio;
said Extender (37) is characterized as follows compared to the prior art:
a) said Extender (37) uses a Gearbox (38); said Gearbox (38) is positioned directly or indirectly after Output Shaft/Spline (13);
a gear ratio of said Gearbox (38) should be changed from a First Gear Ratio to a Second Gear Ratio before Path 2 is changed to Path 1 at the Final Transmission Ratio of Path 2; and the gear ratio of said Gearbox (38) should be changed from said Second Gear Ratio to said First Gear Ratio before Path 1 is changed to Path 2 at the Initial Transmission Ratio of Path 1;
said First Gear Ratio and said Second Gear Ratio of said Gearbox (38) should be selected so that when Path 2 is changed to Path 1 at Final Transmission Ratio of Path 2, the transmission ratio of Extender 37 before Path 2 is changed to Path 1 is identical to the transmission ratio of Extender 37 after Path 2 has been changed to Path 1; and so that when Path 1 is changed to Path 2 at Initial Transmission Ratio of Path 1, the transmission ratio of Extender 37 before Path 1 is changed to Path 2 is identical to the transmission ratio of Extender 37 after Path 1 has been changed to Path 2;
b) said Extender (37) uses a Load Isolating Clutch (39);
said Load Isolating Clutch (39) is preferably positioned anywhere before said Input Shaft/Spline (2) or anywhere after said Output Shaft/Spline (13); so that no load is applied to said Extender (37) once said Load Isolating Clutch (39) is disengaged; since if positioned as such, said Load Isolating Clutch (39) will either disengage said Extender (37) with the engine/motor that drives it, or disengage said Extender (37) with the load that is driven by said Extender (37);
said Load Isolating Clutch (39) should be disengaged when Path 2 is changed to Path 1 at the Final Transmission Ratio of Path 2, and when Path 1 is changed to Path 2 at the Initial Transmission Ratio of Path 1; for all other operations of said Extender (37), except when it is being used as a Neutral Transmission, said Load Isolating Clutch (39) should be engaged;
c) said Input Shaft/Spline Clutch (5A) and said Output Shaft/Spline Clutch (15) are each an Overlap Providing Clutch (56), which is clutch for which an overlap during shifting can be provided or not provided as required.

2. The Extender (37) of claim 1 for which said Overlap Providing Clutch (56) comprises:
a) a Transmission Shaft/Spline 44 on which a Clutch Gear (46), a Blocker Ring 52, a Synchronizer Hub (47), a Blocker Ring 50, a Clutch Gear (42), and a Shift Sleeve 54 are mounted;
said Clutch Gear (46), said Blocker Ring (52), said Blocker Ring (50), and said Clutch Gear (42) can freely rotate relative to said Transmission Shaft/Spline (44); while Synchronizer Hub (47) is fixed for rotation relative said Transmission Shaft/Spline (44);
b) said Clutch Gear (46), which has external teeth;
c) said Blocker Ring (52), which has external teeth;
d) said Synchronizer Hub (47), which has external teeth;
e) said Blocker Ring (50), which has external teeth;
f) said Clutch Gear (42), which has external teeth;
an axial position of Clutch Gear 42 is controlled so that it has two fixed axial positions relative to said Synchronizer Hub (47); the first axial position is the extended axial position, which is when said Clutch Gear (42) is extended; and the second axial position is the retracted axial position, which is when said Clutch Gear (42) is retracted; said extended axial position is used to provide an overlap during shifting; and said retracted axial position to remove an overlap during shifting;
g) said Shift Sleeve (54); said Shift Sleeve (54) is a sleeve that has Internal Teeth (54-S3) that can engage with said teeth of said Clutch Gear (42), said teeth of said Blocker Ring (50), said teeth of said Synchronizer Hub (47), said teeth of said Clutch Gear (46), and said teeth of said Blocker Ring (52);
the width of said Shift Sleeve (54) should be selected so that when said Clutch Gear (42) is retracted; it can either engage/couple said Synchronizer Hub (54) with Clutch Gear (42), or engage/couple said Synchronizer Hub (54) with said Clutch Gear (46); and so that when said Clutch Gear (42) is extended; it can engage/couple said Synchronizer Hub (47) with both said Clutch Gear (46) and said Clutch Gear (42).

3. The Extender (37) of claim 2 for which for said Overlap Providing Clutch (56) that is used as said Input Shaft/Spline Clutch (5A) and said Overlap Providing Clutch (56) that is used as said Output Shaft/Spline Clutch (15), each provide an overlap during shifting when Path 1 is changed to Path 2 at the Final Transmission Ratio of Path 1 and when Path 2 is changed to Path 1 at the Initial Transmission Ratio of Path 2.

4. The Extender (37) of claim 3 for which one said Shift Sleeve (54) is shifted and engaged before the other said Shift Sleeve (54), when Path 1 is changed to Path 2 at the Final Transmission Ratio of Path 1 and when Path 2 is changed to Path 1 at the Initial Transmission Ratio of Path 2;
here said Shift Sleeve (54) of said Input Shaft/Spline Clutch (5A) can be shifted and engaged first, before said Shift Sleeve (54) of said Output Shaft/Spline Clutch (15A) is shifted and engaged; or alternately, the said Shift Sleeve (54) of said Input Shaft/Spline Clutch (5A) can be shifted and engaged first, before said Shift Sleeve (54) of said Output Shaft/Spline Clutch (15A) is shifted and engaged.

5. An Overlap Providing Clutch (56), which comprises:
a) a Transmission Shaft/Spline 44 on which a Clutch Gear (46), a Blocker Ring 52, a Synchronizer Hub (47), a Blocker Ring 50, a Clutch Gear (42), and a Shift Sleeve 54 are mounted;
said Clutch Gear (46), said Blocker Ring (52), said Blocker Ring (50), and said Clutch Gear (42) can freely rotate relative to said Transmission Shaft/Spline (44); while Synchronizer Hub (47) is fixed for rotation relative said Transmission Shaft/Spline (44);
b) said Clutch Gear (46), which has external teeth;
c) said Blocker Ring (52), which has external teeth;
d) said Synchronizer Hub (47), which has external teeth;
e) said Blocker Ring (50), which has external teeth;
f) said Clutch Gear (42), which has external teeth;
an axial position of Clutch Gear 42 is controlled so that it has two fixed axial positions relative to said Synchronizer Hub (47); the first axial position is the extended axial position, which is when said Clutch Gear (42) is extended; and the second axial position is the retracted axial position, which is when said Clutch Gear (42) is retracted; said extended axial position is used to provide an overlap during shifting; and said retracted axial position to remove an overlap during shifting;
g) said Shift Sleeve (54); said Shift Sleeve (54) is a sleeve that has Internal Teeth (54-S3) that can engage with said teeth of said Clutch Gear (42), said teeth of said Blocker Ring (50), said teeth of said Synchronizer Hub (47), said teeth of said Clutch Gear (46), and said teeth of said Blocker Ring (52);
the width of said Shift Sleeve (54) should be selected so that when said Clutch Gear (42) is retracted; it can either engage/couple said Synchronizer Hub (54) with Clutch Gear (42), or engage/couple said Synchronizer Hub (54) with said Clutch Gear (46); and so that when said Clutch Gear (42) is extended; it can engage/couple said Synchronizer Hub (47) with both said Clutch Gear (46) and said Clutch Gear (42).
